(19) United States
(12) Patent Application Publication
(10) Pub. No.: US 2022/0147951 A1
(43) Pub. Date: May 12, 2022

(54) REMOTE VEHICLE SERVICING SYSTEM

(71) Applicant: TOYOTA MOTOR ENGINEERING & MANUFACTURING NORTH AMERICA, INC., PLANO, TX (US)

(72) Inventors: GEOFFREY D. GAITHER, Ann Arbor, MI (US); KAZUNORI HARIMA, Ann Arbor, MI (US)

(21) Appl. No.: 17/094,620

(22) Filed: Nov. 10, 2020

(51) Int. Cl. G06Q 10/00; G06Q 30/00; G06Q 10/10; G06Q 50/18; G06F 21/44; G06F 16/23; G05B 19/4155; G05D 1/00; B60R 25/24; B60L 53/66

(52) U.S. Cl. CPC G06Q 10/20; G06Q 30/016; G06Q 30/0185; G06Q 10/10; G06Q 50/188; G06F 21/44; G06Q 10/06315; G05B 19/4155; G05D 1/0022; B60R 25/241; B60L 53/66; G06Q 2240/00; G06F 16/23

(57) ABSTRACT

Systems and methods provide for remote servicing of vehicles. A network connected servicing vehicle can include a communications component through which the vehicle: negotiate one or more service agreement for servicing a serviced vehicle; receives a location of the serviced vehicle to which the servicing vehicle travels to perform the servicing of the serviced vehicle; authenticates the presence of the servicing vehicle when proximate to the serviced vehicle; and receives one or more instructions for the servicing of the serviced vehicle at the location of the serviced vehicle. Methods can include arranging for a performance of a service on a first vehicle according to a service agreement; providing one or more instructions relating to the service to a second vehicle; and receiving a confirmation of performance of at least one aspect of the service at the location of the first vehicle.

### TECHNICAL FIELD

The present disclosure relates generally to remote vehicle servicing systems.

### DESCRIPTION OF RELATED ART

Currently, to perform routine maintenance, vehicle dealers send a two person team to pick-up a vehicle, drive it to a conventional service facility, service it, and return it to the original pick-up location.

### BRIEF SUMMARY OF THE DISCLOSURE

According to various embodiments of the disclosed technology, the disclosed embodiments may provide remote vehicle servicing system.

Methods described herein can effectuate remote vehicle servicing. Methods can be executed by at least one of a server, a device, a vehicle operator, and/or a servicing vehicle.

Methods described herein can include arranging for a performance of a service on a first vehicle according to a service agreement. The methods can include providing one or more instructions relating to the service to a second vehicle. The instructions can specify at least one aspect of the service to be performed at the location of the first vehicle by the second vehicle and/or an operator of the second vehicle.

The methods can further include receiving a confirmation of performance of at least one aspect of the service at the location of the first vehicle.

The methods can further include providing one or more instructions relating to alignment of an automatic lift system coupled to the second vehicle. The automatic lift system can be configured for lifting the first vehicle for performance of the service, and the instructions can be configured accordingly. The methods can further include providing one or more instructions for lifting of the first vehicle for performance of the service. The instructions can specify the lifting the first vehicle according to a clearance signal from one or more sensor. The one or more sensor can be physically coupled to the first vehicle or the automatic lift system.

The methods can further include one or more instructions relating to alignment of an automatic lift system coupled to the second vehicle. The automatic lift system can be configured for lifting the first vehicle for performance of the service. The instructions can include: (i) the locations of one or more lift points for the first vehicle, and (ii) one or more translation or articulation instructions for the automatic lift system. The translation or articulation instructions can be configured to allow one or more contact points of the automatic lift system to contact the one or more lift points of the first vehicle.

The service agreement can include an agreement for vehicle access. The instructions relating to the service can further include vehicle access instructions. The method can further include providing instructions relating to the service to the first vehicle. The instructions can specify configuring one or more vehicle controls for controlling one or more vehicle access according to a vehicle access setting based on the agreement for vehicle access. The vehicle access setting can include one or more settings for access to at least one compartment of the first vehicle, and one or more settings for access to at least one data related to the first vehicle.

The methods can further include authenticating a device related to the service agreement. The methods can further include receiving a request to access to a compartment of the first vehicle and/or data of the first vehicle. The methods can further include providing a notification to the device of the request to access the compartment and/or data. Moreover, the methods can include receiving a notification regarding the request to access the compartment and/or data from the device. The methods can further include providing an instruction to the first vehicle. The instruction to the first vehicle can include configuring one or more vehicle controls for controlling access to the compartment of the first vehicle according to the received notification regarding the request to access the compartment and/or data. The vehicle controls can be configured to grant access or restrict access (i.e. to the compartment and/or data).

The methods disclosed herein can further include providing instructions relating to the service to the first vehicle. The instructions can specify configuring one or more vehicle controls for controlling one or more vehicle access according to vehicle access settings. The instructions can specify configuring one or more vehicle controls based on an agreement for vehicle access within the service agreement. The vehicle access settings can include one or more settings for access to at least one compartment of the first vehicle. The agreement for vehicle access can include an agreement for vehicle access by a third party. One or more settings for access to the at least one compartment of the first vehicle can include settings for access to the at least one compartment of the first vehicle by the third party.

Arranging for a performance of a service to the first vehicle according to the service agreement can include creating a service agreement smart contract. Receiving a confirmation of performance of at least one aspect of the service comprises receiving a confirmation of execution of one or more components of the service agreement smart contract to automatically update one or more distributed ledger in a Blockchain.

Methods can include authenticating the presence of the second vehicle at a location of the first vehicle. The presence can be authenticated by determining that a respective identity of the first vehicle and the second vehicle are as identified in the service agreement.

The methods described herein can include providing instructions relating to the service to the second vehicle specify the second vehicle to recharge the first vehicle.

The methods can further include providing one or more instructions to a robotic vehicle servicing system operator for performance of at least one aspect of the service by the robotic vehicle servicing system operator.

The methods can further include transmitting an instruction for the first vehicle to exit a service mode. The instructions can specify the vehicle exit the service mode upon receipt of the confirmation of performance of at least one aspect of the service. Receiving the confirmation of performance of at least one aspect of the service can include a confirmation that the service was completed. The at least one aspect of the service can include performance of a maintenance or parts upgrade on the first vehicle. Accordingly the confirmation of performance can confirmation of performance of the maintenance or parts upgrade on the first vehicle.

Embodiments of the present disclosure may include a networked connected servicing vehicle. The networked connected servicing vehicle may enable remote servicing. The network connected servicing vehicle may include a vehicle body. The servicing vehicle may include an actuation component configured for actuating the servicing vehicle.

The servicing vehicle may include a communications component. The networked connected servicing vehicle may negotiate one or more service agreement for servicing a serviced vehicle through the communications component. The networked connected servicing vehicle may receive, through the communications component, a location of the serviced vehicle to which the servicing vehicle travels to perform the servicing of the serviced vehicle. The networked connected servicing vehicle may, through the communications component, authenticate the presence of the servicing vehicle when proximate to the serviced vehicle. The network connected servicing vehicle, may further, through the communications component, receive one or more instructions for the servicing of the serviced vehicle at the location of the serviced vehicle.

The networked connected servicing vehicle can further include an automatic lift system coupled to the vehicle body. The automatic lift system can be configured to align the automatic lift system with the serviced vehicle. The automatic lift system can further lift the serviced vehicle for performance of the service based on a clearance signal. The clearance signal can be from one or more sensor physically coupled to the serviced vehicle or the automatic lift system.

The vehicle body of the network connected servicing vehicle can include one or more battery configured to recharge the serviced vehicle, for example, if the service agreement comprises a recharge service. The battery can be physically coupled to the vehicle body such that the battery comprises at least a portion of a ballast weight of the vehicle body. The ballast weight can be such that it allows the lift system to lift the serviced vehicle, for example, without leaning or tilting.

The networked connected servicing vehicle can further include a sensor.

The presence of the servicing vehicle proximate to the serviced vehicle can be authenticated by scanning a serviced vehicle identification by the sensor of the mobile servicing vehicle.

The networked connected servicing vehicle can further include an automatic lift system coupled to the vehicle body. The automatic lift system can be configured to determine the locations of one or more lift points for the serviced vehicle based on the scanned vehicle identification. The automatic lift system can be configured to lift the serviced vehicle for performance of the service by contacting one or more contact points of the automatic lift system with one or more lift points of the serviced vehicle.

One or more instructions received by the servicing vehicle for the servicing of the serviced vehicle at the location of the serviced vehicle can specify one or more vehicle access setting. The vehicle access settings can specify a level of access to at least one compartment of the first vehicle and/or to one or more data of the serviced vehicle. Access to the serviced vehicle is based on the authentication.

Other features and aspects of the disclosed technology will become apparent from the following detailed description, taken in conjunction with the accompanying drawings, which illustrate, by way of example, the features in accordance with embodiments of the disclosed technology. The summary is not intended to limit the scope of any inventions described herein, which are defined solely by the claims attached hereto.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments.

FIG. 1A is a schematic representation of an example (hybrid) vehicle with which embodiments of the systems and methods disclosed herein may be implemented.

FIG. 1B illustrates an example architecture for detecting and entering a service mode in accordance with one embodiment of the systems and methods described herein.

FIG. 2 illustrates an example representation of a remote vehicle servicing system.

FIG. 3 illustrates an example vehicle lift system with which embodiments of the systems and methods disclosed herein may be implemented.

FIG. 4A illustrates a diagram of a method for servicing one or more vehicles according to aspects of the present disclosure.

FIG. 4B illustrates a diagram of another method for servicing one or more vehicles according to aspects of the present disclosure.

FIG. 5 is an example computing component that may be used to implement various features of embodiments described in the present disclosure.

The figures are not exhaustive and do not limit the present disclosure to the precise form disclosed.

### DETAILED DESCRIPTION

Conventional vehicle servicing is not automated and is inefficient (e.g. during servicing, but also due to wasted time and resources for effectuating pick up and return of the vehicle). Moreover, conventional vehicle servicing can be inconvenient for the owner of the vehicle (e.g. in the case they must drive the vehicle to the service facility and either wait or drop it off and return later). Further, conventional vehicle servicing does not enable provisioning of real-time information regarding a state of the vehicle, and may not enable privacy and/or security with respect to access to the vehicle. Conventional vehicle servicing is also not dynamic in that services, once arranged, cannot be adapted.

Accordingly, embodiments of the systems and methods disclosed herein enable on-site vehicle service (i.e. service effectuated remotely from a conventional service facility / on-site at the location of the vehicle). The disclosed systems and methods enable vehicle servicing with various automated features, and which comport with environmental considerations, as well as alleviate security and/or privacy concerns. The disclosed on-site servicing would increase efficiency, reduce vehicle downtime, and limit the number of miles accumulated by vehicles. Moreover, embodiments of the systems and methods disclosed herein can help reduce wasted time (both from a dealer and customer perspective), and can also improve overall efficiency when servicing a vehicle. Further still, embodiments of the systems and methods disclosed herein allow for dynamic vehicle servicing.

Accordingly, disclosed is a servicing system including a servicing vehicle equipped with an automated vehicle lift system, and one or more connected devices. Also disclosed are one or more methods for remote vehicle servicing. Activation of a service mode at the vehicle can enable automatic arranging of a service at the location of the vehicle by the servicing vehicle. The disclosed servicing system can enable dynamic and/or automatic adjustment of one or more aspects of the service, including the level of vehicle access.

At the vehicle location for the service, autonomous operations of the servicing vehicle and the serving system can be enabled by scanning of the vehicle identification (e.g. vehicle identification number (VIN)) and/or by detection of the servicing vehicle or another device at a proximity to the serviced vehicle. Moreover, access to the serviced vehicle can be autonomously and/or remotely enabled, such as by remote enabling or unlocking of doors and/or hood of the serviced vehicle. Vehicle access can be enabled according to an authentication and according to a vehicle access setting. The vehicle access setting can include minimal vehicle access necessary for completion of the service. The system can include detection of pre-programmed lift points for automatic lifting of the serviced vehicle. The servicing system can include wireless sensor to prevent any collisions by use of the automated vehicle lift system. It can be understood that these are merely non-limiting examples of the disclosed methods, systems, and functionalities. Further detail and other embodiments will be described herein.

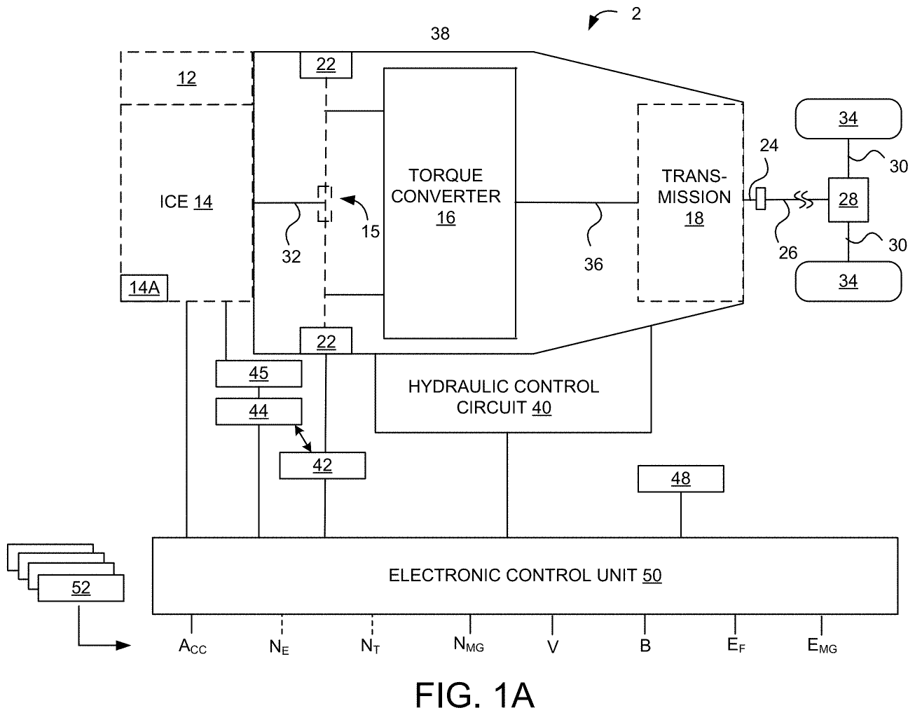

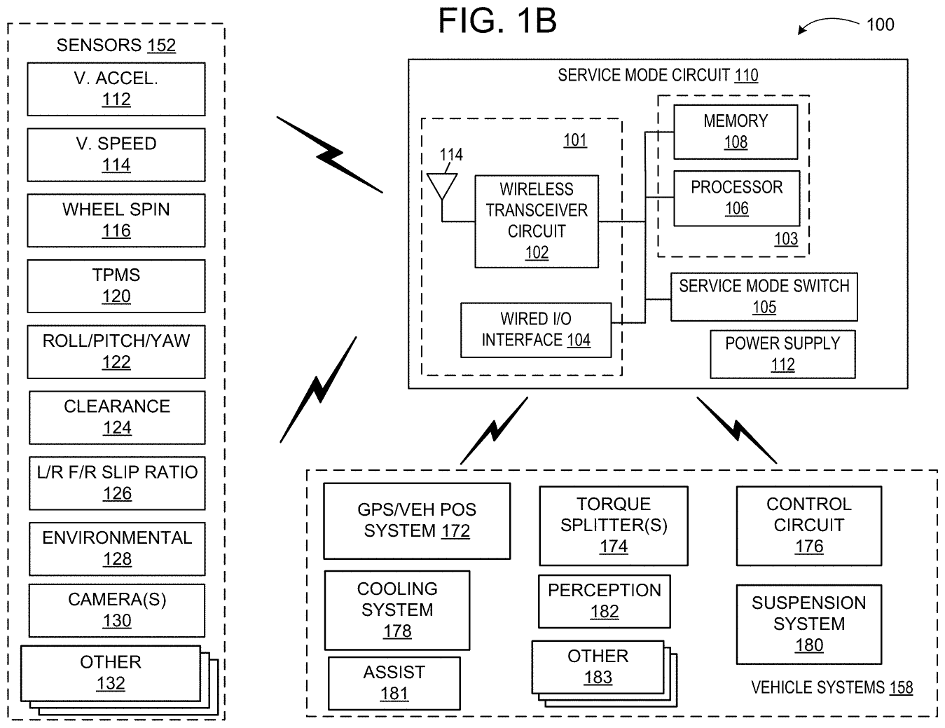

Before describing embodiments of the disclosed system and methods in detail, it is useful to describe example vehicles that the disclosed systems and methods can be implemented with. The systems and methods disclosed herein may be implemented with any of a number of different vehicles and vehicle types. For example, the systems and methods disclosed herein may be used with automobiles, trucks, motorcycles, recreational vehicles and other like on-or off-road vehicles. In addition, the principals disclosed herein may also extend to other vehicle types as well, such as aerial (e.g. aircraft, drones) and/or submersible (e.g. watercraft, boats) vehicles. An example hybrid electric vehicle (HEV) in which embodiments of the disclosed technology may be implemented is illustrated in FIG. 1A. Although the example described with reference to FIG. 1A is a hybrid type of vehicle, the systems and methods for remote vehicle servicing can be implemented in other types of vehicle including gasoline- or diesel-powered vehicles, fuel-cell vehicles, electric vehicles, or other vehicles.

FIG. 1A illustrates a drive system of a vehicle 2 that may include an internal combustion engine 14 and one or more electric motors 22 (which may also serve as generators) as sources of motive power. Driving force generated by the internal combustion engine 14 and motors 22 can be transmitted to one or more wheels 34 via a torque converter 16, a transmission 18, a differential gear device 28, and a pair of axles 30.

As an HEV, vehicle 2 may be driven/powered with either or both of engine 14 and the motor(s) 22 as the drive source for travel. For example, a first travel mode may be an engine-only travel mode that only uses internal combustion engine 14 as the source of motive power. A second travel mode may be an EV travel mode that only uses the motor(s) 22 as the source of motive power. A third travel mode may be an HEV travel mode that uses engine 14 and the motor(s) 22 as the sources of motive power. In the engine-only and HEV travel modes, vehicle 102 relies on the motive force generated at least by internal combustion engine 14, and a clutch 15 may be included to engage engine 14. In the EV travel mode, vehicle 2 is powered by the motive force generated by motor 22 while engine 14 may be stopped and clutch 15 disengaged.

Engine 14 can be an internal combustion engine such as a gasoline, diesel or similarly powered engine in which fuel is injected into and combusted in a combustion chamber. A cooling system 12 can be provided to cool the engine 14 such as, for example, by removing excess heat from engine 14. For example, cooling system 12 can be implemented to include a radiator, a water pump and a series of cooling channels. In operation, the water pump circulates coolant through the engine 14 to absorb excess heat from the engine. The heated coolant is circulated through the radiator to remove heat from the coolant, and the cold coolant can then be recirculated through the engine. A fan may also be included to increase the cooling capacity of the radiator. The water pump, and in some instances the fan, may operate via a direct or indirect coupling to the driveshaft of engine 14. In other applications, either or both the water pump and the fan may be operated by electric current such as from battery 44.

An output control circuit 14A may be provided to control drive (output torque) of engine 14. Output control circuit 14A may include a throttle actuator to control an electronic throttle valve that controls fuel injection, an ignition device that controls ignition timing, and the like. Output control circuit 14A may execute output control of engine 14 according to a command control signal(s) supplied from an electronic control unit 50, described below. Such output control can include, for example, throttle control, fuel injection control, and ignition timing control.

Motor 22 can also be used to provide motive power in vehicle 2 and is powered electrically via a battery 44. Battery 44 may be implemented as one or more batteries or other power storage devices including, for example, lead-acid batteries, lithium ion batteries, capacitive storage devices, and so on. Battery 44 may be charged by a battery charger 45 that receives energy from internal combustion engine 14. For example, an alternator or generator may be coupled directly or indirectly to a drive shaft of internal combustion engine 14 to generate an electrical current as a result of the operation of internal combustion engine 14. A clutch can be included to engage/disengage the battery charger 45. Battery 44 may also be charged by motor 22 such as, for example, by regenerative braking or by coasting during which time motor 22 operate as generator.

Motor 22 can be powered by battery 44 to generate a motive force to move the vehicle and adjust vehicle speed. Motor 22 can also function as a generator to generate electrical power such as, for example, when coasting or braking. Battery 44 may also be used to power other electrical or electronic systems in the vehicle. Motor 22 may be connected to battery 44 via an inverter 42. Battery 44 can include, for example, one or more batteries, capacitive storage units, or other storage reservoirs suitable for storing electrical energy that can be used to power motor 22. When battery 44 is implemented using one or more batteries, the batteries can include, for example, nickel metal hydride batteries, lithium ion batteries, lead acid batteries, nickel cadmium batteries, lithium ion polymer batteries, and other types of batteries.

An electronic control unit 50 (described below) may be included and may control the electric drive components of the vehicle as well as other vehicle components. For example, electronic control unit 50 may control inverter 42, adjust driving current supplied to motor 22, and adjust the current received from motor 22 during regenerative coasting and breaking. As a more particular example, output torque of the motor 22 can be increased or decreased by electronic control unit 50 through the inverter 42.

A torque converter 16 can be included to control the application of power from engine 14 and motor 22 to transmission 18. Torque converter 16 can include a viscous fluid coupling that transfers rotational power from the motive power source to the driveshaft via the transmission. Torque converter 16 can include a conventional torque converter or a lockup torque converter. In other embodiments, a mechanical clutch can be used in place of torque converter 16.

Clutch 15 can be included to engage and disengage engine 14 from the drivetrain of the vehicle. In the illustrated example, a crankshaft 32, which is an output member of engine 14, may be selectively coupled to the motor 22 and torque converter 16 via clutch 15. Clutch 15 can be implemented as, for example, a multiple disc type hydraulic frictional engagement device whose engagement is controlled by an actuator such as a hydraulic actuator. Clutch 15 may be controlled such that its engagement state is complete engagement, slip engagement, and complete disengagement complete disengagement, depending on the pressure applied to the clutch. For example, a torque capacity of clutch 15 may be controlled according to the hydraulic pressure supplied from a hydraulic control circuit (not illustrated). When clutch 15 is engaged, power transmission is provided in the power transmission path between the crankshaft 32 and torque converter 16. On the other hand, when clutch 15 is disengaged, motive power from engine 14 is not delivered to the torque converter 16. In a slip engagement state, clutch 15 is engaged, and motive power is provided to torque converter 16 according to a torque capacity (transmission torque) of the clutch 15.

As alluded to above, vehicle 2 may include an electronic control unit 50. Electronic control unit 50 may include circuitry to control various aspects of the vehicle operation. Electronic control unit 50 may include, for example, a microcomputer that includes a one or more processing units (e.g., microprocessors), memory storage (e.g., RAM, ROM, etc.), and I/O devices. The processing units of electronic control unit 50, execute instructions stored in memory to control one or more electrical systems or subsystems in the vehicle. Electronic control unit 50 can include a plurality of electronic control units such as, for example, an electronic engine control module, a powertrain control module, a transmission control module, a suspension control module, a body control module, and so on. As a further example, electronic control units can be included to control systems and functions such as doors and door locking, lighting, human-machine interfaces, cruise control, telematics, braking systems (e.g., ABS or ESC), battery management systems, and so on. These various control units can be implemented using two or more separate electronic control units, or using a single electronic control unit.

In the example illustrated in FIG. 1A, electronic control unit 50 receives information from a plurality of sensors included in vehicle 2. For example, electronic control unit 50 may receive signals that indicate vehicle operating conditions or characteristics, or signals that can be used to derive vehicle operating conditions or characteristics. These may include, but are not limited to accelerator operation amount, A_{CC}, a revolution speed, N_{E}, of internal combustion engine 14 (engine RPM), a rotational speed, N_{MG}, of the motor 22 (motor rotational speed), and vehicle speed, N_{V}. These may also include torque converter 16 output, N_{T} (e.g., output amps indicative of motor output), brake operation amount/pressure, B, battery SOC (i.e., the charged amount for battery 44 detected by an SOC sensor). Accordingly, vehicle 102 can include a plurality of sensors 52 that can be used to detect various conditions internal or external to the vehicle and provide sensed conditions to engine control unit 50 (which, again, may be implemented as one or a plurality of individual control circuits). In one embodiment, sensors 52 may be included to detect one or more conditions directly or indirectly such as, for example, fuel efficiency, E_{F}, motor efficiency, E_{MG}, hybrid (internal combustion engine 14+MG 12) efficiency, mileage, speed, acceleration, Acc, emissions, occupancy, conditions of the environment, manifold temperature/pressure, air temperature, coolant temperature, throttle position, oxygen levels, adaptive fuel, engine cylinder fire/misfire, injection system flow, evaporative emissions, exhaust gas recirculation, mass airflow, gas cap state, the open or close state of one or more doors or other openings of the vehicle 2, etc.

In some embodiments, one or more of the sensors 52 may include their own processing capability to compute the results for additional information that can be provided to electronic control unit 50. In other embodiments, one or more sensors may be data-gathering-only sensors that provide only raw data to electronic control unit 50. In further embodiments, hybrid sensors may be included that provide a combination of raw data and processed data to electronic control unit 50. Sensors 52 may provide an analog output or a digital output.

Sensors 52 may be included to detect not only vehicle conditions but also to detect external conditions as well. Sensors that might be used to detect external conditions can include, for example, sonar, radar, lidar or other vehicle proximity sensors, and cameras or other image sensors. Image sensors can be used to detect, for example, parking spots, other vehicles, traffic signs indicating a current speed limit, road curvature, obstacles, and so on. Still other sensors may include those that can detect road grade. While some sensors can be used to actively detect passive environmental objects, other sensors can be included and used to detect active objects such as those objects used to implement smart roadways that may actively transmit and/or receive data or other information.

As alluded to above, various embodiments enable vehicles to be remotely serviced. Remote servicing of vehicles, in accordance with one embodiment, may comprise detecting that the vehicle requires service. Detection that the vehicle requires service can activate a service mode at the vehicle. Thus, in embodiments, activation of the service mode at the vehicle can enable remote servicing of vehicles according to aspects of the present disclosure.

FIG. 1B illustrates an example architecture for detecting a service mode and entering into a service mode in accordance with one embodiment of the systems and methods described herein. Detection of a service mode can indicate a need for the vehicle (or another vehicle) to be serviced. A service mode can be for on-site servicing as described in the present disclosure. Referring now to FIG. 1B, in this example, service system 100 includes a service mode circuit 110, a plurality of sensors 152, and a plurality of vehicle systems 158. Sensors 152 and vehicle systems 158 can communicate with service mode circuit 110 via a wired or wireless communication interface. Although sensors 152 and vehicle systems 158 are depicted as communicating with service mode circuit 110, they can also communicate with each other as well as with other vehicle systems. Service mode circuit 110 can be implemented as an ECU or as part of an ECU such as, for example electronic control unit 50. In other embodiments, service mode circuit 110 can be implemented independently of the ECU.

Service mode circuit 110 can be configured to activate and/or detect a service mode. Service mode circuit 110 in this example includes a communication circuit 101, a decision circuit (including a processor 106 and memory 108 in this example) and a power supply 112. Components of service mode circuit 110 are illustrated as communicating with each other via a data bus, although other communication in interfaces can be included. Service mode circuit 110 in this example also includes a service mode switch 105 that can be operated by the user to manually select the service mode.

Processor 106 can include a GPU, CPU, microprocessor, or any other suitable processing system. The memory 108 may include one or more various forms of memory or data storage (e.g., flash, RAM, etc.) that may be used to store the calibration parameters, images (analysis or historic), point parameters, instructions and variables for processor 106 as well as any other suitable information. Memory 108, can be made up of one or more modules of one or more different types of memory, and may be configured to store data and other information as well as operational instructions that may be used by the processor 106 to service mode circuit 110.

Although the example of FIG. 1B is illustrated using processor and memory circuitry, as described below with reference to circuits disclosed herein, decision circuit 103 can be implemented utilizing any form of circuitry including, for example, hardware, software, or a combination thereof. By way of further example, one or more processors, controllers, ASICs, PLAs, PALs, CPLDs, FPGAs, logical components, software routines or other mechanisms might be implemented to make up a service mode circuit 110.

Communication circuit 101 either or both a wireless transceiver circuit 102 with an associated antenna 114 and a wired I/O interface 104 with an associated hardwired data port (not illustrated). As this example illustrates, communications with service mode detection/activation circuit 110 can include either or both wired and wireless communications circuits 101. Wireless transceiver circuit 102 can include a transmitter and a receiver (not shown) to allow wireless communications via any of a number of communication protocols such as, for example, WiFi, Bluetooth, near field communications (NFC), Zigbee, and any of a number of other wireless communication protocols whether standardized, proprietary, open, point-to-point, networked or otherwise. Antenna 114 is coupled to wireless transceiver circuit 102 and is used by wireless transceiver circuit 102 to transmit radio signals wirelessly to wireless equipment with which it is connected and to receive radio signals as well. These RF signals can include information of almost any sort that is sent or received by service mode circuit 110 to/from other entities such as sensors 152 and vehicle systems 158.

Wired I/O interface 104 can include a transmitter and a receiver (not shown) for hardwired communications with other devices. For example, wired I/O interface 104 can provide a hardwired interface to other components, including sensors 152 and vehicle systems 158. Wired I/O interface 104 can communicate with other devices using Ethernet or any of a number of other wired communication protocols whether standardized, proprietary, open, point-to-point, networked or otherwise.

Power supply 112 can include one or more of a battery or batteries (such as, e.g., Li-ion, Li-Polymer, NiMH, NiCd, NiZn, and NiH₂, to name a few, whether rechargeable or primary batteries), a power connector (e.g., to connect to vehicle supplied power, etc.), an energy harvester (e.g., solar cells, piezoelectric system, etc.), or it can include any other suitable power supply.

Sensors 152 can include additional sensors that may or not otherwise be included on a standard vehicle (e.g. vehicle 2) with which the service mode circuit 110 is implemented. In the illustrated example, sensors 152 include vehicle acceleration sensors 112, vehicle speed sensors 114, wheelspin sensors 116 (e.g., one for each wheel), a tire pressure monitoring system (TPMS) 120, accelerometers such as a 3-axis accelerometer 122 to detect roll, pitch and yaw of the vehicle, vehicle clearance sensors 124, left-right and front-rear slip ratio sensors 126,venvironmental sensors 128 (e.g., to detect salinity or other environmental conditions), and camera(s) 130 (e.g. front rear, side, top, bottom facing). Additional sensors 132 can also be included as may be appropriate for a given implementation of service system 100.

Vehicle systems 158 can include any of a number of different vehicle components or subsystems used to control or monitor various aspects of the vehicle and its performance. In this example, the vehicle systems 158 include a GPS or other vehicle positioning system 172; torque splitters 174 which can control distribution of power among the vehicle wheels such as, for example, by controlling front/rear and left/right torque split; engine or motor control circuits 176 to control the operation of motor, engine (e.g. internal combustion engine 14), or other actuation component; cooling systems 178 to provide cooling for the motors, power electronics, the engine, the cabin, or other vehicle systems; suspension system 180 such as, for example, an adjustable-height air suspension system; assist circuit(s) 181, such as automated vehicle systems/advanced driver assistance systems (ADAS) adapted for any level of vehicle control and/or driving autonomy; perception systems 182, such as machine perception systems, which can include one or more computer or machine vision or recognition systems; and other vehicle systems and/or circuits 183. Assist circuit(s) 181 can be adapted for level 1, level 2, level 3, level 4, and/or level 5 autonomy (for example, as described in Society of Automotive Engineers (SAE) J3016).

During operation, service mode circuit 110 can receive information from various vehicle sensors 152 and/or vehicle systems 158 to determine whether the service mode should be activated. For example, the service mode can be activated to indicate one or more faults in vehicle systems 158. As yet another example, the service mode can be activated to indicate needed upgrades of vehicle systems 158 (such as expiration of an expected lifetime of a vehicle system 168), which can be addressed by a service to the vehicle. Also, the driver, owner, insurer, dealer, and/or operator of the vehicle may manually activate the service mode by operating service mode switch 105. Communication circuit 101 can be used to transmit and receive information between service mode circuit 110 and sensors 152, and service mode circuit 110 and vehicle systems 158. Also, sensors 152 and/or service mode circuit 110 may communicate with vehicle systems 158 directly or indirectly (e.g., via communication circuit 101 or otherwise). Communication circuit 101 can be used to transmit and receive information between service mode circuit 110, one or more other systems of a vehicle 2, but also other vehicles, devices, systems and/or infrastructure. For example, via communication circuit 110, service mode switch 105 can be activated by receipt of a command from infrastructure and/or another device.

In various embodiments, communication circuit 101 can be configured to receive data and other information from sensors 152 and/or vehicle systems 158 that is used in determining whether to activate the assist mode. Additionally, communication circuit 101 can be used to send an activation signal or other activation information to various vehicle systems 158 as part of entering, remaining, or exiting the service mode. For example, as described in more detail below, communication circuit 101 can be used to send signals to, for example, one or more of: torque splitters 174 to control front/rear torque split and left/right torque split; motor controllers 176 to, for example, control motor torque, motor speed of the various motors in the system; ICE control circuit 176 to, for example, control power to engine (e.g., to shut down the engine so all power goes to the rear motors, to ensure the engine is running to charge the batteries or allow more power to flow to the motors); cooling system (e.g., 178 to increase cooling system flow for one or more motors and their associated electronics); suspension system 180 (e.g., to increase ground clearance such as by increasing the ride height using the air suspension). The decision regarding what action to take via these various vehicle systems 158 can be made based on the information detected by sensors 152. Examples of this are described in more detail below. As another example, upon entering, remaining, and/or exiting service mode, communication circuit 101 can be used to send an activation signal and/or activation information to one or more vehicle systems 158 for the vehicle to take certain actions for a performance of a service. For example, activation signals can allow for the vehicle to park (e.g. by assist 181, perception 182, control 176, and/or other 183 circuits or systems) and/or lock/unlock the door and/or hood of the vehicle. As another example, upon exiting the service mode (e.g. upon completion of a service), communication circuit 101 can be used to send an activation signal or other activation information to one or more vehicle systems 158 for the vehicle to navigate to one or more waypoints. Further, during activation of service mode the communication circuit 101 can send a signal to infrastructure and/or a device regarding the status of the vehicle. Moreover, upon exiting service mode, the communication circuit 101 can send a signal that an aspect of the service has been completed (or that service mode has been exited).

The examples of FIGS. 1A and 1B are provided for illustration purposes only as examples of vehicle systems with which embodiments of the disclosed technology may be implemented. One of ordinary skill in the art reading this description will understand how the disclosed embodiments can be implemented with vehicle platforms.

As previously discussed, activation and/or detection of a service mode (e.g. by service mode circuit 110) can indicate a need for performance of one or more services. As alluded to above, various embodiments enable vehicles to be remotely serviced. Before describing embodiments of the disclosed system and methods in detail, it may be useful to describe example services that be performed and/or enabled by various embodiments of the present disclosure. One or more services can include routine or non-routine maintenance and/or vehicle upgrades. Thus, services can include routine check-ups (such as fluid, shock, tire pressure, oil, coolant, brake fluid, air filter, tire tread, belt, front and/or rear differential inspection). Other maintenance can include oil change, tire rotation, air filter change, headlight replacement, transmission fluid replacement, windshield wiper replacement. Also, services can include refueling and/or recharging services. Moreover, services can include cleaning and/or disinfecting services. Services can include upgrade of parts (such as tires, exhaust, electronics, entertainment system, etc.).

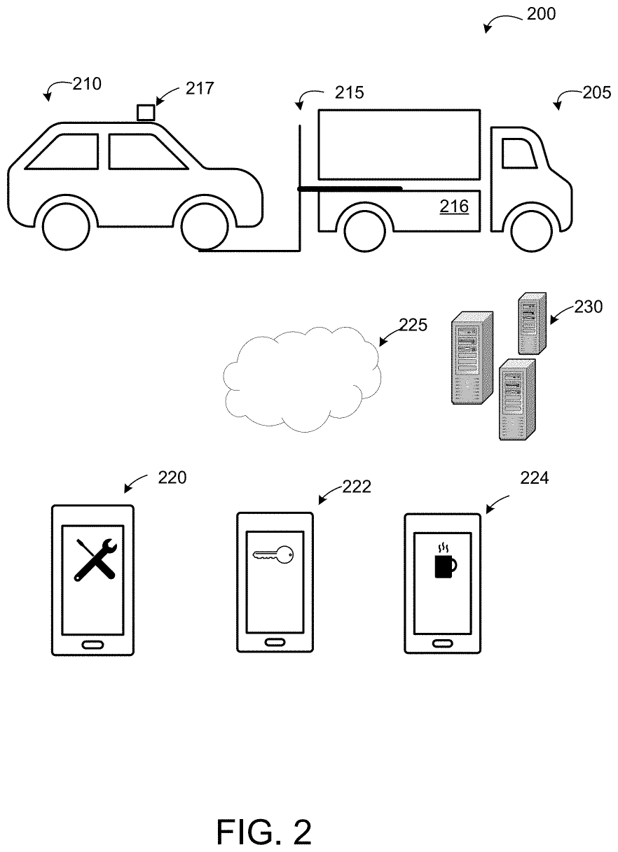

Accordingly, and as illustrated by FIG. 2, example remote vehicle servicing system 200 is described as enabling the performance of one or more services, including upon detection of a service mode.

As previously alluded to, remote vehicle servicing can be enabled by an equipped servicing vehicle. In the context of a service enabled by an equipped servicing vehicle, parties to the service can include the driver, owner, operator of the serviced vehicle, an individual or entity performing the service, and/or driver, owner and/or operator of the servicing vehicle.

The remote vehicle servicing system 200 can include one or more components. The components can physically enable performance of one or more aspects of the service. The components can also enable one or more functionality. The components of the remote vehicle servicing system 200 can include, for example a servicing vehicle 205, serviced vehicle 210, and vehicle lift system 215. The components of the remote vehicle servicing system 200 can each comprise a unique identity and/or identifier which can enable one or more authentication of components which is described in more detail herein. The one or more components can include one or more devices, such as a servicing system operating device 220, serviced vehicle owner/operator device 222, and/or third party device 224. Such devices will be described in more detail herein. The remote vehicle servicing system 200 can also include one or more server 230 as a component of the system, which will also be described in more detail herein. Each of the one or more components can be communicatively coupled to a network 225.

The servicing vehicle 205 and/or serviced vehicle 210 can each be configured as vehicle 2 shown in FIG. 1A, and/or with service system 100 shown in FIG. 1B. Now referring to servicing vehicle 205, servicing vehicle 205 can be configured for servicing the serviced vehicle 210. For example, a service mode (e.g. at service mode circuit 110) can be enabled at servicing vehicle 205 and/or serviced vehicle 210 for performance of a service to the servicing vehicle 205. As another example, a service mode (e.g. at service mode circuit 110) can be enabled which can allow servicing vehicle 205 to service a vehicle to be serviced, e.g., serviced vehicle 210.

Arrangement of Services

In embodiments, activation of a service mode at the serviced vehicle 210 can allow for scheduling or otherwise arranging performance of the service by service vehicle servicing system 200. The service can be arranged (e.g. by notification of activation of the service mode) by one or more component of remote vehicle servicing system 200, or a party to the service (e.g. by receipt of notification of entering into the service mode). For example, servicing vehicle 205, serviced vehicle 210, devices, and/or server 230 can each individually or in combination arrange or negotiate the arrangement of the service. Accordingly, the remove vehicle servicing system 200, the servicing vehicle 210, and/or the server 230, can include components which enable negotiation and/or arrangement of the service. For example, servicing vehicle 205 and/or serviced vehicle 210 can negotiate by component of service system 100 such as service mode circuit 110 and/or another circuit 183. Negotiation and/or arrangement of the service can be performed automatically, for example by communication of the serviced vehicle 205, the servicing vehicle 210, and/or the server 230.

Negotiation and/or arrangement of a service can include negotiation and/or arrangement of a service arrangement, which can include one or more service dimensions. Service arrangements as described herein can include selection of a servicing vehicle for the service (i.e. from a fleet of servicing vehicles) and/or selection of a time and/or place for the service. Service arrangements can include parts, vehicle access, duration, and/or price for the service, or for one or more aspects of the service. For example, a negotiated service arrangement can be mutually beneficial for the parties to the service. Although some service dimensions of a service arrangement are listed herein, other service dimensions are within the scope of the disclosure. One or more aspects of the service arrangement can be documented or otherwise arranged as part of a service agreement. Thus, the service agreement can be an agreement (i.e. between one or more parties and/or beneficiaries, of the service and/or components of the system) regarding one or more aspects of the service and/or service arrangement. It is understood that one or more steps with respect to the service can be performed according to the service agreement. In embodiments, activation of the service mode (e.g. at the serviced vehicle 210), can trigger the service agreement to be created by respective parties and/or components of the remote vehicle servicing system 200.

As previously discussed, arrangement and/or negotiation of the service can include selection of a servicing vehicle for the service (i.e. from a fleet of servicing vehicles) and/or selection of a time and/or place for the service. For example, the vehicle servicing system 200 (and/or component thereof, and/or one or more parties to the service) can schedule and/or arrange for performing an immediate (in time) service, and/or a future service. The servicing vehicle 205 selected for performing the service can be a servicing vehicle that is available to service another vehicle and/or adequately equipped to service the vehicle. For example, the selected servicing vehicle (i.e. from a fleet of servicing vehicles) can have the requisite inventory (e.g. tools and/or parts) needed to perform one or more services. As another example, the selected vehicle can be located in a geographic vicinity to the serviced vehicle 210. The geographic vicinity can be, for example, within 0.25 to 45 miles, or such that the selected servicing vehicle can arrive to the vehicle at a reasonable time (such as in 5-30 minutes), and/or at an arranged time. The reasonableness of the time can depend on the context of the service, such as the type of service, and/or the type of vehicles. The geographic vicinity can be relative to the context of this disclosure, e.g. the type of servicing vehicle 205 and/or serviced vehicle 210. The geographic vicinity is not necessarily limited to a particular distance or range. In embodiments, the servicing vehicle 205 can be directed to an intermediate waypoint, such as at one or more infrastructure (e.g. warehouse) locations for replenishing of inventory. In embodiments, the servicing vehicle 205 can be directed to one or more vehicles to be serviced, and by a specific .

One or more of these service arrangements may be preferable to a driver, owner, and/or operator of the serviced vehicle 210, in that accumulated mileage, wear, and/or downtime of the serviced vehicle 210 is minimized. Further, vehicle access and/or privacy of the owner, driver and/or operator of the serviced vehicle 210 can be customized. Either of these service arrangements may allow for environmentally friendly servicing, in that servicing for one or more vehicles may be optimized so that overall the travel distance and/or down-time for vehicles are minimized. The service arrangements may allow for efficient servicing, in that the resources of the remote vehicle servicing system 200 (such as time and/or inventory of servicing vehicle 205) are efficiently allocated. Aspects of the present disclosure allow for dynamically adjusting one or more aspects of service arrangements so that the needs of individual serviced vehicles 210, but also the fleet of servicing vehicles and/or the collective needs vehicles to be serviced are considered.

Once the service is arranged, information regarding the service can be provided to the one or more components of the system 200, and/or parties to the service. Thus, components of the system 200 can be configured to provide such information to other components, for example, by the network 225. The information can include information regarding the time and/or location of the service, and/or the identity of the selected servicing vehicle 210. The information can include the previously mentioned service agreement.

For performing of the service, servicing vehicle 205 may be able to navigate to the agreed location (i.e. in the previously mentioned service agreement). Servicing vehicle 205 may be able to navigate to an on-site location of the serviced vehicle 210. Thus, servicing vehicle 205 may be able to track the real-time location of the serviced vehicle 205. Moreover, the servicing vehicle 205 and/or serviced vehicle 210 could have arranged to meet at a mutually convenient (or otherwise arranged) location and/or time. Navigation to the on-site location of the serviced vehicle 210 (or another location) can be performed by assist circuit(s) 181 perception systems 182. Thus, the serviced vehicle 210 may be able to navigate to the servicing vehicle 205 and/or to the mutually convenient, or otherwise arranged location autonomously.

Performance of Service and Components of Servicing System

At the location of the serviced vehicle 210, the vehicle servicing system 200 may enable performing on one or more service to the serviced vehicle 210.

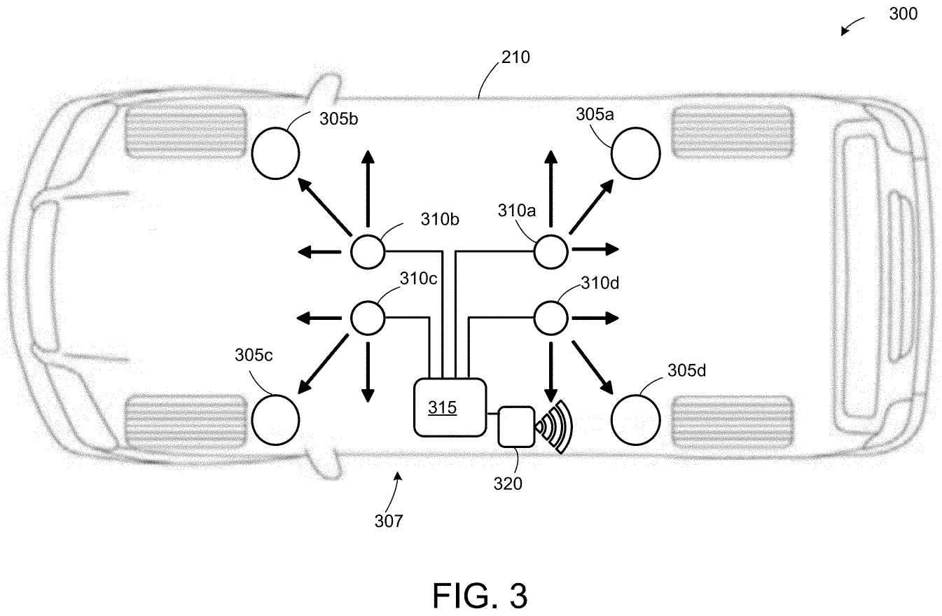

Servicing vehicle 205 can be equipped with a vehicle lift system 215. Vehicle lift system 215 can enable remote servicing of the serviced vehicle 210. Vehicle lift system 215 can remain coupled to servicing vehicle 205 to lift the serviced vehicle 210. Vehicle lift system 215 can be selectively coupled or uncoupled to servicing vehicle 205, in that the vehicle lift system 215 can detach from the servicing vehicle 205 for performing of the service. The servicing vehicle 205 (and/or system 200 operator) can align the servicing vehicle 205 (e.g. at a vicinity of the serviced vehicle 210 with by assist circuit(s) 181) so that the vehicle lift system 215 is positioned in an optimal position for aligning with and/or lifting the serviced vehicle 210. Vehicle lift system 215 is shown in further detail in FIG. 3.

The servicing vehicle 205 can have one or more portions (e.g. compartments) for storing one or more supplies to assist with servicing. Such supplies can include tools (such as ramp, mechanics creepers, wheel dollies, diagnostic tools, repair kits), consumables (such as cleaning products, oils, fluids, lighting equipment), and/or parts to be replaced or upgraded during the service. The servicing vehicle 205 may be able to maintain, update, and/or report inventory of such supplies, for example by one or more sensors (such as cameras, hall sensors, weight sensors, etc.). The servicing vehicle 205 can have one or more towing equipment for towing serviced vehicle 210.

The servicing vehicle 205 may also be able to store one or more replaced and/or consumed portions of serviced vehicle 210. As previously noted, the servicing vehicle 205 can allow for upgrade or replacement of parts of the serviced vehicle 210, in addition to performing of maintenance services. The servicing vehicle 205 can allow for storage of one or more parts to be upgraded or replaced, such as wheels for the serviced vehicle 210. For example, the servicing vehicle 205 may have one or more receptacles for storing discarded parts, such as tires, but also one or more discarded fluids. The servicing vehicle 205 may be able to maintain, update, and/or report inventory of such things that can be stored from serviced vehicle 210.

The servicing vehicle 205 may have or maintain one or more energy sources (e.g. by a battery or fuel) stored in the servicing vehicle 205. The servicing vehicle 205 may also be able to provide electrical energy by converting a mechanical energy from the internal combustion engine (ICE). The servicing vehicle 205 may be configured with one or more chargers, such as plug-in charging cables and/or connectors (e.g. SAE J1772 standard), and/or wireless chargers (e.g. SAE J2954 standard). The one or more chargers can allow the servicing vehicle 205 to charge one or more battery of the serviced vehicle 210. Thus, the servicing vehicle 205 may include at least one alternator, generator, inverter and/or converter coupled to the battery, the ICE 14, the charging cable and/or connector, and/or the wireless charger.

The servicing vehicle 205 can be an electric or hybrid vehicle. The servicing vehicle 205 can have one or ballast weight to assist the vehicle servicing system 200 (e.g. by vehicle lift system 215) to lift the serviced vehicle 210. The ballast weight can be helpful to vehicle lift system 215 performance. The ballast weight can be located at a lower portion (or another portion) of a vehicle body 216 of the servicing vehicle 205. One or more battery of the servicing vehicle 205, and/or fuel tank of the servicing vehicle 205 can act as the ballast weight.

The servicing vehicle 205 can include one or more sensor for scanning (or reading) the VIN of the serviced vehicle 210 (or another identification of the serviced vehicle 210, such as Quick Response (QR) code). Scanning can be performed, for example, by a camera, barcode scanner, or sensor of the servicing vehicle 205. Scanning (or reading) the VIN of the serviced vehicle 210 can allow for authentication of the serviced vehicle 210 (and/or of the servicing vehicle 210).

The vehicle servicing system 200 can include at least one sensor 217 configured to detect a proximity (i.e. a distance) to any ceiling(s) or wall(s) to prevent collisions of the serviced vehicle 210 and/or vehicle lift system 215 when the vehicle lift system 215 is in use. Sensor 217 can generate a signal which can correspond to the proximity, and/or a clearance from the sensor to the ceiling(s) or wall(s). Sensor can be attached (or part of) serviced vehicle 210. Sensor 217 can be a wireless or wired sensor. Sensor 217 can be attached at least one of the roof or sides of the serviced vehicle 210 to judge proximity to any ceilings to prevent collision. The sensor 217 can be attached to the serviced vehicle 210 by a vehicle servicing system 200 operator (not shown). The sensor 217 can alternatively (or in addition, i.e. by a second sensor, not shown) be attached to vehicle lift system 215.

The vehicle servicing system 200 (e.g. sensor of servicing vehicle 205) can be configured to read or otherwise detect (such as by pairing) a vehicle identification number (VIN) of the serviced vehicle 210 (or other identification number, such as a license plate identification). Identification of the serviced vehicle 210 by the vehicle servicing system 200 can enable one or more autonomous operations of the vehicle servicing system 200. Identification of the serviced vehicle 210 can allow for the vehicle servicing system 200 to relay pertinent information to one or more parties of the service and/or components of the vehicle servicing system 200 related to the service and about the serviced vehicle 210. Such information can include pre-determined lift positions for the serviced vehicle 210, one or more specifications for the service (such as alignment specifications, fluid capacities and weight), vehicle mass, vehicle mileage, vehicle service history (e.g. information regarding prior services for the serviced vehicle 210, such as the history of recurrent issues).

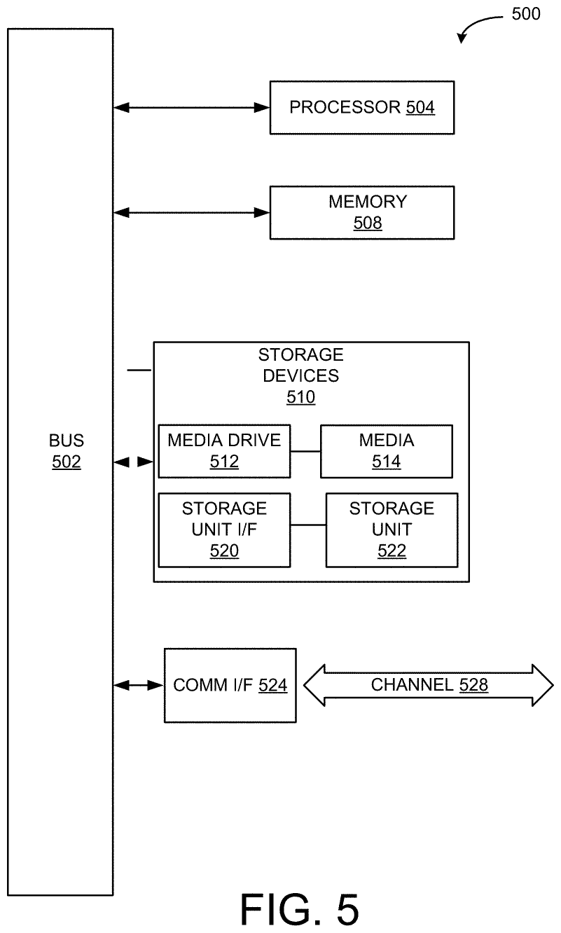

As previously mentioned, the vehicle servicing system 200 can include one or more devices which can be configured for providing and/or receiving information regarding the service. The one or more devices can allow for parties and/or non-parties to the service to interact, for example to arrange, negotiate, and/or be appraised of one or more aspects of the service arrangement. The vehicle servicing system 200 can include a servicing system operating device 220, serviced vehicle owner/operator device 222, and/or third party device 224. One or more of the devices can be network 225 connected devices, and can include on or more interfaces for connecting to other devices and/or components of the vehicle servicing system 200, such as WiFi or Bluetooth. One or more of the devices can be authenticated for receiving and/or transmitting one or more data related to the service. The devices can include one or more computing component, example of which is shown in detail in FIG. 5. The devices can be configured as or to include one or more application or software on device (such as a personal computer or cell phone). The application and/or software can be downloaded and/or executed on the device. It can be understood that the devices can be integral to or separate to one or more other components of the vehicle servicing system 200. For example, servicing system operating device 220 can be separate to or part of servicing vehicle 205, and/or serviced vehicle owner/operator device 222 can be separate to or part of the serviced vehicle 210.

The servicing system operating device 220 can be configured for operation by a vehicle servicing system 200 operator (not shown, but can be another component of system 200, and/or a component of the servicing vehicle 205). The vehicle servicing system 200 operator can be the vehicle servicer (i.e. an individual or entity performing the service) or an agent thereof. The vehicle servicing system 200 operator can be a human technician, and/or a robotic (e.g. autonomous) operator which can be coupled to the servicing vehicle 205 and/or to the lift system 215 (e.g. communicatively and/or physically coupled).

The vehicle servicing system 200 operator can at least partially include, or be part of, the servicing system operating device 220, the servicing vehicle 205, and/or vehicle lift system 215. The vehicle servicing system 200 operator can be configured at least partially as vehicle 2 as described herein. The vehicle servicing system 200 operator can enable performance of one or more service requests to the serviced vehicle 210. For example, the system operator (e.g. a robotic operator or human technician) can perform one or more tire rotations for the serviced vehicle 210 by removing and rotating two or more of the tires of the serviced vehicle 210. As another example, the system operator (e.g. a robotic operator or human technician), and/or another component of the vehicle servicing system 200, can fuel/refuel and/or charge/recharge the serviced vehicle 210. This can be facilitated by an energy stored at servicing vehicle 205. The vehicle servicing system 200 operator can activate or otherwise control one or more components of the vehicle servicing system 200, such as servicing vehicle 205 or vehicle lift system 215 for performance of one or more aspects of the service.

Robotic vehicle servicing system 200 operator can be remotely operated and/or autonomously operated. The robotic vehicle servicing system 200 operator can be selectively controlled such that (e.g. by electromechanical actuator, pneumatic actuator, etc.) one or more movements are controlled by the robotic vehicle servicing system 200 operator. Such movements can include, for example, translations, articulations, actuations, gripping, object manipulations. The robotic vehicle servicing system 200 operator can be control across one or more axis and/or articulation points or joints. Robotic vehicle servicing system 200 operator can include one or more sensing or identification components. For example, robotic vehicle servicing system 200 operator can thus be configured to identify and/or manipulate objects, and/or be controlled and/or actuate based on sensing measurements, imaging measurements, displacement measurements, and/or other measurements. Robotic vehicle servicing system 200 operator can comprise a computing or processing component capable of carrying out the described servicing functionality. One such example computing component is shown in FIG. 5. For example, processing or computing component may determine how to manipulate the object and/or otherwise control the robotic vehicle servicing system 200 operator based on the identified objects.

The servicing system operating device 220 can allow for scanning (or reading) the VIN of the serviced vehicle 210 (or another identification of the serviced vehicle 210, such as QR code). Scanning can be performed, for example, by a camera, barcode scanner, or sensor of the servicing system operating device 220. Scanning (or reading) the VIN of the serviced vehicle 210 can allow for authentication of the serviced vehicle 210. The servicing system operating device 220 can include a diagnostic module configured for diagnosing one or more service related issues of the serviced vehicle 210, and/or verifying that one or more services need to be completed and/or were completed (e.g. by evaluating diagnostic codes). For example, the servicing system operating device 220 can interface with an on-board diagnostic port, such as OBD2 port, (or another port and/or wired or wireless interface) of the serviced vehicle 210.

The serviced vehicle owner/operator device 222 can be configured as an application or software on device (such as a personal computer or cell phone) that can be accessed by serviced vehicle 210 owner and/or operator. The serviced vehicle owner/operator device 222 can alternatively or in addition, be part of the serviced vehicle 210. For example, the serviced vehicle owner/operator device 222 can include a display console and/or computing component of the serviced vehicle 210. The serviced vehicle owner/operator device 222 can allow for the owner/operator of the serviced vehicle 210 to receive and/or transmit one or more information regarding the service, or otherwise interact with parties and/or non-parties to the service. For example, a request for a service, and/or a request for altering a service request, can be completed at serviced vehicle owner/operator device 222. The request can be provided to service mode circuit 110 shown in FIG. 1B for activation and/or entry into a service mode for the serviced vehicle 210 based on the request. As another example, a status of the service and/or vehicle servicing system 200 can be provided to the serviced vehicle owner/operator device 222. One or more instructions, notifications, and/or confirmations regarding that status can be received from the serviced vehicle owner/operator device 222. The status of the service and/or vehicle servicing system 200 can include information regarding authentication, performance of one or more aspects of the service, and/or a state of a component of the system 200. For example, the status can include information that a compartment of the serviced vehicle 210 is open, or if that the vehicle 210 is lifted off the ground. As another example, payment information can be provided to serviced vehicle owner/operator device 222. The serviced vehicle owner/operator device 222 can also facilitate completing a payment transaction for the service, such as by a payment circuit of the device 222.

The vehicle servicing system 200 can include one or more third party device 224. The third party device 224 can be configured as an application or software on device (such as a personal computer or cell phone) that can be accessed by a third party (e.g. a non-party or a non-original party to the service). The third party device 224 can allow for the third party to receive and/or transmit one or more information regarding the service, or otherwise interact with parties and/or non-parties to the service. One or more information regarding the service performed by vehicle servicing system 200, can be provided to third party device 224, and/or provided for access by the third party device 224.

In embodiments, the third party can be a used vehicle market or an insurance provider. The used vehicle market or the insurance provider can be provided with information regarding the service (i.e. by the third party device 224). The information regarding the service can be used to update a service history of the serviced vehicle 210. The information regarding the service and/or the service history can be used to update a value or valuation of the serviced vehicle 210. For example, a value of the serviced vehicle 210 can be maintained and/or increased if timely maintenance was performed during the service, and/or genuine or Original Equipment Manufacturer (OEM) parts were used during the service. In contrast, the value of the serviced vehicle can be maintained and/or decreased if non-OEM parts were used during the service. In embodiments, a price or value for the service can be based on if the owner/operator of the serviced vehicle (or another party or non-party paying for the service), opts in to providing information to third parties (such as non-parties).

One or more information based on the service can be provided to the third party (e.g. by third party device 224). For example, a third party (i.e. by way of the third party device 224, or otherwise), can be provided information related to the service being performed or requested (such as the type of service, the duration of the service, the cost of the service), the location of at least one component of the vehicle servicing system 200 (such as the location of the serviced vehicles 210, the servicing vehicle 205, the serviced vehicle owner/operator device 222, the servicing system operating device 220). The third party device 224, and/or the system vehicle servicing system 200 can enable one or more parties to the service to sell information regarding the service to third parties.

The vehicle servicing system 200 can allow for enabling the vehicle servicing system 200 to provide the one or more information to the third party (e.g. at the third party device 224). For example, owner/operator of the serviced vehicle 210 (e.g. by an interaction with serviced vehicle owner/operator device 222) can enable or disable the third party (e.g. by the third party device 224) to receive or access information regarding the service. In embodiments, enabling of the information to be provided to the third party can result in a discount and/or price reduction for the service being performed.

In embodiments, the third party (e.g. by third party device 224) can provide one or more information to the vehicle servicing system 200 or party to the vehicle servicing system 200. This information can be provided, to one or more of the other parties, by the respective device (e.g. to the owner and/or operator of the serviced vehicle 210, e.g. by way of the serviced vehicle owner/operator device 222). For example, the third party, or the vehicle servicing system 200, can direct one or more advertisements to be presented at the serviced vehicle owner/operator device 222. The advertisements can be related to the service, such as recommendations for one or more added-on services to be performed, such as recommendations for one or more upgrades. The information can be related to the location of one or more components of the vehicle servicing system 200 and/or duration of the service. For example, the owner/operator of the serviced vehicle 210 (i.e. by device 222) can be provided with information regarding retail stores in the vicinity of the service. The information can include information regarding availability of one or more retail, merchandise, service (i.e. food or drink) in the vicinity of the serviced vehicle owner/operator device 222. In embodiments, activation of such functionality can reduce a cost of service. In embodiments, the owner/operator of the serviced vehicle 210 (i.e. by serviced vehicle owner/operator device 222) can enable such functionality. In embodiments, an interaction at serviced vehicle owner/operator device 222 based on the information at that device received from the third party, can enable one or more services to be completed, and/or can enable renegotiation of the service agreement. Thus, this functionality of vehicle servicing system 200 can enable one aspect of dynamic vehicle servicing.

The vehicle servicing system 200 can have enabled one or more vehicle access settings. Vehicle access setting can allow for tailoring access to the serviced vehicle 210 to meet a level of privacy expected by the vehicle owner and/or operator. Vehicle access settings can be adjusted by the vehicle owner and/or operator, for example, at the service vehicle owner/operator device 222. Thus, the disclosed systems provide for dynamic vehicle servicing by way of dynamic vehicle access settings. Examples of vehicle access settings, and the access to the serviced vehicle 210 activation of the setting affords to the vehicle servicing system 200 operator, are meant to be non-limiting examples.

One or more software setting can be enabled by the presence of the servicing vehicle 205 and/or servicing system operating device 220, proximate to the serviced vehicle 210. The proximity can be such that can allow for physical access to the serviced vehicle 210 by a component of the remote vehicle servicing system 200. The proximity can be depend on various factors in the context of this disclosure, e.g., the type of service to be performed, the type of servicing vehicle 205 and/or serviced vehicle 210.

Proximate does not limit the disclosure to a particular distance or range. The presence of the servicing vehicle 205 and/or the servicing system operating device 220 proximate to the servicing vehicle 210 can be detecting by one or more sensors and/or communication and/or pairing schemes, such as by Bluetooth, NFC, WiFi. Thus the proximity can be based on a line of sight, and/or a near or mid-field communication signal distance. The presence of the servicing vehicle 205 and/or servicing system operating device 220 proximate to the serviced vehicle 210 can be detected by performance of one or more authentication. Authentication can include the previously described scanning (or reading) of the VIN of the serviced vehicle 210 (or another identification of the serviced vehicle 210). Other examples of authentication will be described in detail herein.

The software setting can be enabled onboard the serviced vehicle 210. One or more enabled software setting can remotely enable one or more doors or latches of the serviced vehicle 210, such as the door, hood latch, and/or internal or external compartment. One or more software setting for remote servicing can provide at least partial access to one or more physical portions of the serviced vehicle 210, and/or data related to the serviced vehicle 210. As such, the software setting can be a vehicle access setting.

For example, as previously discussed, the vehicle servicing system 200 can allow for the owner/operator of the serviced vehicle 210 to interact with (e.g. by the serviced vehicle owner/operator device 222) the vehicle servicer and/or a third party. The vehicle servicing system 200 (e.g. at the serviced vehicle owner/operator device 222) can allow for the owner/operator of the serviced vehicle 210 to place an order for one or more service and/or merchandise from the third party. In embodiments, an order can be placed at the serviced vehicle owner/operator device 222, and the third party can arrange for delivery of one or more merchandise at the location of the serviced vehicle 210. The vehicle servicing system 200 can allow for the one or more merchandise to be delivered to the serviced vehicle 210, for example, by unlocking one or more compartments (such as a trunk) of the serviced vehicle 210. The vehicle servicing system 200 can verify that one or more merchandise have been delivered to the serviced vehicle 210, e.g. by the activation of one or more sensors (such as door sensors and/or weight sensors). By way of example, the vehicle servicing system 200 (i.e. component thereof) can lock the one or more compartments of the serviced vehicle 210 once the merchandise have been delivered.

For example, a minimal vehicle access setting can allow for just enough access to the serviced vehicle 210 (i.e. physical and/or data access) for maintenance to be completed by the remote vehicle servicing system 200. Under the minimal vehicle access setting, one or more compartments of the serviced vehicle 210 can remain locked, such as the trunk and/or glove comportment. Moreover, activation of the minimal vehicle access setting may allow vehicle servicing system 200 operator to turn on the vehicle, but not move the vehicle, switch to a certain gear, and/or move the vehicle more than a particular distance (such as 0.5-10 meters, or 1-20 full tire rotations). Under the minimal vehicle access setting, the system operator may have access to no or minimal data regarding the serviced vehicle 210. For example, the vehicle servicing system 200 operator could have access to vehicle 210 diagnostic data. As another example, the vehicle servicing system 200 operator could be prevented from gaining access to data regarding identifying features of the serviced vehicle 210 and/or of the serviced vehicle owner/operator. For example, the vehicle servicing system 200 operator could not access data regarding preprogrammed destinations, waypoints, home or other significant locations, GPS data, preferences for vehicle settings (radio stations, temperature settings), video camera or other security and/or navigation feeds.

A medium vehicle access setting can enable, for example, access to the vehicle servicing system 200 operator to physical compartments (such as the hood and/or a passenger cabin of serviced vehicle 210) so as to complete the maintenance, and access to more data related to the serviced vehicle 210 compared to the data available by the minimal vehicle access setting. For example, the vehicle servicing system 200 operator can have access to data relevant for performing the service, such the vehicle servicing system 200 operator can include serviced vehicle 210 mileage, and/or the time since last service.

Upon activation of one or more levels for vehicle access settings, the vehicle servicing system 200 operator's ability to override certain data at the serviced vehicle 210 can be prevented. For example, the vehicle servicing system 200 can disable or enable access to the serviced vehicle 210 for resetting one or more diagnostic data at the serviced vehicle 210. As another example, the vehicle servicing system 200 could allow the vehicle servicing system 200 operator access to write or override certain vehicle 210 data. As yet another example, the vehicle servicing system 200 can disable or enable access to the serviced vehicle 210 based on an authentication described herein. Thus, access to the serviced vehicle can be granted if an attempt to access the vehicle 210 is by an authenticated party, or if a specific key sequence (e.g. at servicing system operating device 220) is input.

The system 200 can include one or more other components which can be connected to the network 225 (and/or otherwise support the system 200). These can include one or more network level infrastructure (such as displays, network access points, GPS, workstations, and/or server(s) 230), but also vehicle servicing related infrastructure, such as warehouses, storage stations, disposal infrastructure, charging and/or refueling infrastructure. Such infrastructure can support real-time awareness (e.g. of locations and/or other states) of components of the vehicle servicing system 200, but also of multiple of systems.

As previously discussed, the system 200 can further include one or more server 230. Server 230 can be a web server that can include one or more software application or modules. The term “web server” is used to describe both the software application or modules executing on a computing component (i.e. of the server 230), as well as the computing component itself. Example computing component is shown in FIG. 5. Software modules include mechanisms for implementing (i.e. automatically implementing) one or more functionality as described herein. The one or more server can provide centralized storage and/or memory that can be used by one or more components of the remote vehicle servicing system 200 and/or can make available one or more information to the other components of the remote vehicle servicing system 200. has a connection to the internet via a firewall.

As previously alluded to, one or more components of the vehicle servicing system 200 can be network 225 connected (and/or be connected to the internet). For example, one or more components of the remote vehicle servicing system 200 (including the servicing vehicle 205, the serviced vehicle 210, the lift system 215, the servicing system operating device 220, the serviced vehicle owner/operator device 222, the third party device 224, the server(s) 230) can be connected to the network 225. For example, serviced vehicle 210 and/or servicing vehicle 205 communication circuit 201 can connect to the network 225 by communication circuit 110 shown in FIG. 1. The vehicle servicing system 200 can update one or more status (e.g. a state) of components or sub-component of the vehicle servicing system 200 (such as the servicing vehicle 205, the serviced vehicle 210, and/or the lift mechanism 215). The status of components of the vehicle servicing system 200 can be updated in real-time (i.e. provided to one or more network 225 connected components and/or devices) and be provided to one or more parties or non-parties (i.e. by the one or more devices).

The vehicle servicing system 200 (i.e. a component and/or device thereof) can download one or more information from the network 225 (e.g. from one or more component of the system 200). For example, upon scanning the VIN or otherwise identifying the serviced vehicle 210, the vehicle servicing system 200 can download one or more information regarding the serviced vehicle 210, such as information that can facilitate performing of the service by the vehicle servicing system 200 (and/or parties thereof). In addition, information regarding a service agreement can be downloaded.

For example, one or more parties to the service (such as the owner/operator of the serviced vehicle 210, or the servicer) can be provided accessibility information (such as if the vehicle 210 is locked or unlocked, or that has been accessed), information regarding the time of servicing (such as a start time and/or end-time), location information (e.g. of the serviced vehicle 210 and/or the servicing vehicle 205). Moreover, other information can include possible barriers to accessing the vehicle (such as a passcode to access the vehicle). Other information can include information related to the service, such as information regarding what vehicle maintenance is needed or any special requests. Other information can include things in vehicle to avoid (such as avoid turning on the vehicle), Instructions not to open one or more compartments of the vehicle 210, such as the trunk, etc.

In embodiments, the vehicle servicing system 200 can utilize one or more Blockchain (public and/or private), distributed ledger, and/or smart contract technology. For example, the vehicle servicing system 200 can retain the vehicle service (e.g. maintenance or parts replacement and/or upgrade)/or vehicle access history on a blockchain (e.g. with nodes on either or all of components of the remote vehicle servicing system 200, but also on other systems). As another example, the vehicle servicing system 200 can use a smart contract on the blockchain network for vehicle (or data) access (e.g. for security and/or privacy), and/or servicing vehicle 205 and/or serviced vehicle 210 (or other system 200 component) authentication.

In embodiments, one or more service scheduled, negotiated, or otherwise agreed to or arranged, can be documented in one or more service agreement. Service agreement can include an initial agreement, but also follow-on agreements. The service agreement can be or include a smart contract and/or distributed ledger on the blockchain (service agreement smart contract). The service agreement smart contract can include one or more components, such as an authentication component, a vehicle access component, privacy component, a service level component (e.g. having to do with performance of one or more services), and/or third party component.

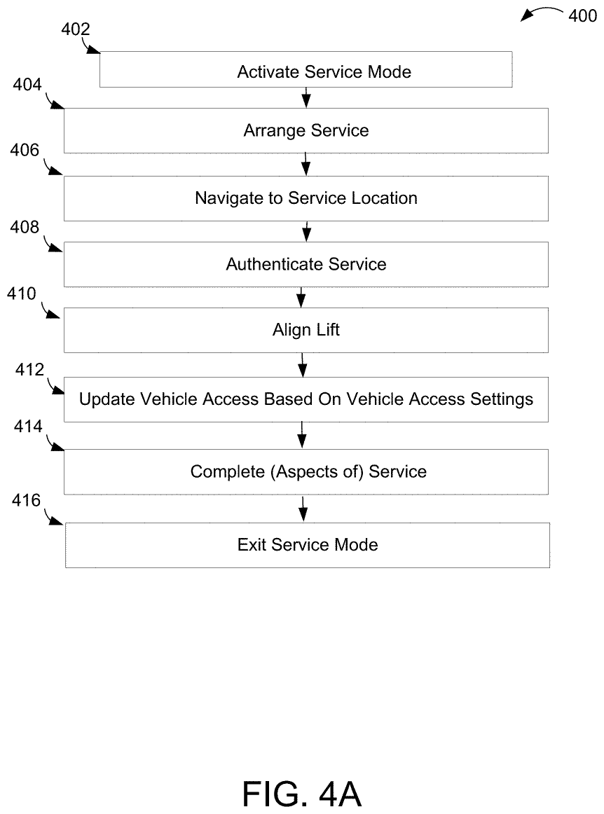

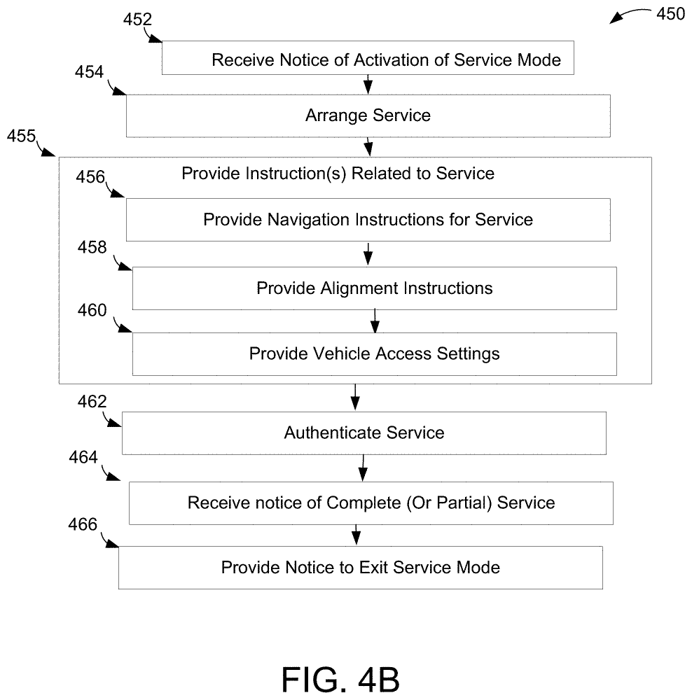

In embodiments, activation of the service mode (e.g. at the serviced vehicle 210), can trigger the service agreement to be created by respective parties and/or components of the remote vehicle servicing system 200, and/or the service agreement smart contract to be created and/or negotiated by the parties and/or components of the remote vehicle servicing system 200. In embodiments, execution of one or more steps for servicing (examples of which are shown in FIG. 4A and/or FIG. 4B), can trigger and/or execute one or more components of the service agreement smart contract, and/or trigger other smart contracts to be created and/or executed.

In embodiments, network 225 can comprise a Blockchain network. A service agreement smart contract can be created, stored and/or deployed in the Blockchain network. The service agreement smart contract in the Blockchain can be accessed (e.g. by one or more components of the vehicle servicing system 200) via the Blockchain network. For example, scanning the vehicle 210 VIN (or otherwise identifying the vehicle 210 identification) can allow for one or more devices and/or components of the remote vehicle servicing system 200 to search for and access the service agreement smart contract.

The service agreement smart contract in the Blockchain can be executed to determine whether one or more parties (e.g. the servicer, and/or a third party) and/or system 200 components (e.g. lift system 215 and/or servicing vehicle 205) is authenticated for approval to: (i) access the serviced vehicle 210 (i.e. components, compartments, or data thereof), (ii) to perform one or more aspect of the service, and/or (iii) to access another component of the system 200. For example, upon scanning of the VIN (or otherwise identifying the serviced vehicle 210), and/or determining the serviced vehicle 210 is proximate to the servicing vehicle 205, the system 200 can determine if the serviced vehicle 210 is authenticated to access the network 225 and/or be serviced by servicing vehicle 205.

Executing the smart contract in the Blockchain can include verifying, e.g. from one or more parties and/or components using the Blockchain, that the agreement is approved, and/or the parties and/or components are authenticated. Executing the smart contract in the Blockchain can include analyzing the smart contract to the determine the party or system 200 component attempting to access the vehicle 210 (or another component of the system 200) is authenticated (e.g. by use of one or more authenticated devices, by one or more parties, or as noted in the service agreement) for approval to access the vehicle 210 (or another component of the system 200. Executing the smart contract in the Blockchain can also include determining that the owner, driver, operator, of the serviced vehicle 210, the serviced vehicle 210, and/or the serviced vehicle owner/operator device 222 has an agreement (i.e. the service agreement and/or smart contract service agreement) with the party and/or system 200 component attempting to access the serviced vehicle 210 (or attempting to access another component of the system 200, or attempting to perform one or more aspect or step of the service). The vehicle servicing system 200 can thus determine that the party or component of the system 200 is authenticated for approval to access the vehicle 210 (i.e. portion thereof, or another component of the system 200).

Similarly, the vehicle servicing system 200 can determine that the party (or non-party) and/or component of the system 200 is authenticated to receive one or more aspects of the service (or receive notice thereof). Similarly, the vehicle servicing system 200 can determine that the party (or non-party) and/or component of the system 200 is authenticated perform one or more aspects of the service. For example, the service agreement smart contract in the Blockchain can be executed to determine whether the serviced vehicle 210 can be lifted (i.e. by vehicle lift system 215), moved, driven, and/or that a service or aspect of a service can be performed. Thus, one or more components of the service agreement smart contract can be executed, and/or updated upon partial and/or full performance of one or more steps of performing the service, and/or by one or more authentication or verification as described herein.

One or more distributed ledgers in the Blockchain can be associated to the one or more parties (or non-parties) to the service, and/or components of the service system 200 (such as the servicing vehicle 205, serviced vehicle 210, and/or the one or more devices). A distributed ledger in the Blockchain associated with the service agreement smart contract (and/or associated with a party, non-party, and/or system 200 component) can be updated with authentication data, and/or other data associated to the service agreement (or parties thereof). For example, a distributed ledger in the Blockchain can include one or more inventory for the servicing vehicle 205. Data related to the inventory can be updated on the distributed ledger based one the service (i.e. based on execution of one or more components of the service agreement smart contract). As another example, a distributed ledger in the Blockchain can include service schedules, and/or route segments for servicing vehicles described herein. In embodiments, execution of one or more steps for servicing (examples of which are shown in FIG. 4A and/or FIG. 4B), can trigger one or more components of the service agreement smart contract to update one or more distributed ledger in the Blockchain. As another example, a distributed ledger in the Blockchain can include one or more service history for the serviced vehicle 210. Data related to the service history can be updated on the distributed ledger based on the service. Moreover, as yet another example, a distributed ledger in the Blockchain can include an account of an owner, driver, operator of the serviced vehicle 210, and/or an account of the serviced vehicle 210. Data related to the account (such as credits and/or debits) can be updated on the distributed ledger in the Blockchain based on performance (or non-performance) of the service (e.g. based on execution of one or more components of the service agreement smart contract).

As yet another example, one or more information regarding the service performed with the vehicle servicing system 200, can be provided to third party (e.g. by third party device 224, and/or provided for access by the third party and/or third party device 224) as part of a distributed ledger in the Blockchain. Moreover, the third party can include one or more third party smart contracts, or entities which can execute one or more smart contracts. For example, the third party can be a used vehicle market (which can include a used vehicle smart contract), or an insurance provider (which can include an insurance smart contract). The used vehicle market smart contract or the insurance provider smart contract can be provided with information regarding the service. For example, information regarding the service can be used to update a service history of the serviced vehicle 210 and/or a value or valuation of the serviced vehicle 210 in a distributed ledger in the Blockchain. For example, a value of the serviced vehicle 210 can be maintained and/or increased if timely maintenance was performed during the service (e.g. as indicated and/or executed by service agreement smart contract), and/or genuine or Original Equipment Manufacturer (OEM) parts were used during the service (e.g. as indicated and/or executed by service agreement smart contract). Similarly, the value of the serviced vehicle 210 can be maintained and/or decreased if non-OEM parts were used during the service, as indicated by execution of one or more components of the service agreement smart contract.

Where single components of the vehicle servicing system 200 are shown it is understood that one or more components can be included. For example, the service servicing system 200 can include two or more serviced vehicle(s) 210, and/or two or more vehicle lifts systems 215, two or more servicing vehicles 210, and/or two or more of each of the respective devices 220, 222, 224.

As previously discussed the serviced vehicle 210 can be positioned proximate to the servicing vehicle 205. However, this positioning may not be optimal for servicing. The vehicle servicing system 200 operator (or the serviced vehicle 210, if autonomous) can position the serviced vehicle 210 in a position and/or location more favorable for servicing (e.g. by moving the serviced vehicle 210 and/or by operating the vehicle lift system 215). For example, a present location of the serviced vehicle 210 may not have a necessary physical clearance at or around the serviced vehicle 210 for performing the service. As previously discussed, the vehicle servicing system 200 can include vehicle lift system 215. Vehicle lift system 215 can allow for positioning the serviced vehicle 210 in a position that can be optimal for servicing.

FIG. 3 shows a detailed view of an embodiment of a vehicle lift system 300 and operation thereof, which can be vehicle lift system 215 shown in FIG. 2. Vehicle lift system 300 can be configured for lifting the serviced vehicle, for example serviced vehicle 210 as shown in FIG. 2. The serviced vehicle 210 can include one or more lift points 305 (e.g. 305a, 305b, 305c, 305d). For example, the lift points can be at or near the wheel wells of the vehicle. In general the lift points 305 can be at structural members of the vehicle. Lift points 305 will be described in detail herein.

Vehicle lift system 300 can include a lift mechanism 307. Lift mechanism 307 can be a hydraulic lift mechanism. Lift mechanism 307 can be battery powered. The lift mechanism 307 can be powered by one or more battery of the servicing vehicle 205, or by one or more separate batteries that can be part of the vehicle lift system 300. The vehicle lift system 300 can be environmentally friendly. For example, the lift mechanism 307 incorporating a hydraulic lift system can utilize biodegradable natural or synthetic oils. The vehicle lift system 300 can incorporate self-regeneration technology. For example, the weight of the lifted service vehicle 210 can allow for recharging one or more batteries (i.e. of the vehicle lift system 300 and/or of the servicing vehicle 205) with each lifting and/or lowering cycle of the lift mechanism 307.

Lift mechanism 307 can be autonomous or semi-autonomous. Lift Mechanism 307 can be collapsible. Vehicle lift system 300 can include one or more lift mechanism 307 contact points 310 (310a, 310b, 310c, 310d shown). Vehicle lift system 300 can include one or more computing and articulation control component 315. Computing and articulation control component 315 can include one or more computing components, example of which is shown in FIG. 5. Lift mechanism 307 contact points 310 can be configured to make contact with the serviced vehicle 210, such as at the underside of the serviced vehicle 210. Lift mechanism 307 can include one or more of a scissor lift or a jack (or other lifting mechanism). Thus lift mechanism 307 contact points 310 can be contact points for respective portions of the lift mechanism 307 (such as scissor lift, and/or jack mechanism contact points) to contact respective lift points 305 of the serviced vehicle 210. Lift mechanism 307 can perform one or more movements and/or articulations. One or more movements and/or articulations can be controlled by computing and articulation control component 315. Computing and articulation control component 315 can be coupled to one or more sensors (not shown). The sensors can provide one or more information to computing and articulation control component 315, such as the current position of the lift mechanism 307 (or portions thereof), and/or a position of the vehicle lift system 215, lift mechanism 307 (or portion thereof) in relation to one or more objects in the vicinity (such as components of vehicle servicing system 200, walls, ceilings, parking spaces, etc.).

Computing and articulation control component 315 can be coupled to a communication component 320. Communication component 320 can facilitate communication, for example, to one or more components of the vehicle servicing system 200, such as the network 225, such as vehicle 205, vehicle 210, and/or devices. Although a wireless communication link is shown at communication component 320, (e.g. for connection to network 225), it is understood that this can be or include a wired communication link. A wired and/or wired communication can be between the lift system 300 and the servicing vehicle 205 to which the lift system 300 is coupled, to the sensor 217, and/or to the device 220.

Lift mechanism 307 can automatically center the lift 307 under the serviced vehicle 210 (i.e. serviced vehicle 210 as shown in FIG. 2). Centering and/or otherwise moving and/or translating the lift mechanism 307 towards the serviced vehicle 210, can be an example of a course alignment. Lift mechanism 307 can locate one or more lift points 305 of the serviced vehicle 210. The lift points 305 can be found by accessing one or more database (e.g. at server 230) comprising known lift positions for the serviced vehicle 210. These can be based on serviced vehicle 210 VIN or other identification information. In some embodiments, the information regarding the lift points 305 is downloaded to component of vehicle servicing system 200 (or otherwise known by the vehicle servicing system 200) after the serviced vehicle 210 identification is known by the component (e.g. after scanning the VIN). The location of the lift points 305 (i.e. in the database) can be determined by determining a reference measurement (i.e. a distance from, along one or more dimensions) with respect to a reference point. The locations of the lift points 305 can be defined with respect to one or more reference points, such as: (i) a perimeter of the serviced vehicle 210; (ii) a side of the serviced vehicle 210; (iii) a component of the serviced vehicle 210 (such as a front or rear bumper) (iv) a geometric center of the serviced vehicle 210, (v) wheel wells of the serviced vehicle 210; (vi) a location of a parking space (and with respect to how the service vehicle 210 is parked within the parking space); and/or (vii) with respect to each other.

The lift mechanism 307 can reposition the contact points 310 to contact the lift points 305 based on the reference points and/or based on the reference measurement. The lift points 305 can be found by cameras or other sensors of the lifting mechanism (or another portion of the servicing vehicle servicing system 200). For example, the serviced vehicle 210 can include one or more visual (or other) indicators (such as a reflective paint and/or a specific pattern) on the underside of the body of the vehicle where the lift points 310 are located. In embodiments, locating the lift points by cameras or other sensors can allow for verifying one or more information in a database (or otherwise downloaded) regarding the lift points, and/or updating that information.

Lift mechanism 307 can automatically center the lift mechanism 307 between the one or more lift points 205 of the serviced vehicle 210. This can be an example of a fine alignment (as compared to a coarse alignment). Lift mechanism 307 may be able to autonomously (or semi-autonomously) articulate and/or position the lift mechanism 307 contact points 310, for example, by articulating one or more posts that can include the contact points 310 at respective terminal ends of the respective posts. The lift mechanism 307 can separately control the one or more lift mechanism 307 contact points 310, and can place the contact points 310 at appropriate positions for lifting the serviced vehicle 210. The lift mechanism 307 can lift the serviced vehicle 210 off the ground. The lift mechanism 307 can lift the serviced vehicle 210 off the ground so that a reasonable clearance (i.e. enough space for performing of the service) is maintained between the serviced vehicle 210 and the ground. The lift mechanism 307 can lift the serviced vehicle 210 based on a reading from the sensor 217 (or another sensor of the vehicle servicing system 200). For example, the lift mechanism 307 can lift the serviced vehicle 210 such that a clearance is maintained between the serviced vehicle 210 and one or more walls and/or ceiling as indicated by a reading from the sensor 217 (or another sensor). The lift mechanism 307 can lift, but could also tilt, translate, or otherwise reposition the serviced vehicle 210. For example, the serviced vehicle 210 can be repositioned for better access (i.e. by a party or operator described herein), and/or for a better parking position.

The lift system 300 can include one or more wired chargers, including charging cables and/or connectors which can couple with a charging port of the serviced vehicle 210. The lift system 300 can include one or more wireless chargers, which can couple with a wireless charger of the serviced vehicle 210 (e.g. at the underside of serviced vehicle 210 per the SAE J2954 standard). Lift mechanism 307 can automatically center the lift 307 under the serviced vehicle 210, position the one or more lift mechanism 307 contact points 310, but also position the one or more chargers for optimum charging of the serviced vehicle 210.

FIG. 4A illustrates diagram of method 400 for performing vehicle servicing of one or more vehicle according to aspects of the present disclosure. One or more steps of method 400 can be performed by either of the components of the vehicle servicing system, for example, components described with reference to FIG. 1A - FIG.3.

Method 400 can include step 402 for activating a service mode of a vehicle. For example, serviced vehicle 210 as shown in FIG. 2 can include service mode system 100 shown in FIG. 1B. Activation of service mode can include as described with reference to service mode circuit 110 shown in FIG. 1B, and/or servicing vehicle servicing system 200 shown in FIG. 2. Activation of service mode can be completed by the serviced vehicle and/or servicing vehicle, with instruction and/or command by a server and/or other network connected device or infrastructure as described herein.

Method 400 can include step 404 for arranging a service. Arranging a service can include scheduling and/or negotiating a service to be performed. The service can be arranged according to one or more service dimensions of the arranged service. The service dimensions can include, the location, time, parts, vehicle access (i.e. vehicle access or other privacy setting, including access setting for data), duration, third party involvement, and/or price for the service. A service can be arranged according to aspects as described herein, include as shown with reference to FIG. 2.

The service can be arranged by one or more parties to the service, and/or by one or more components of the servicing system 200, including as described with reference to FIG. 2. For example, arranging one or more services can include creating one or more service arrangements, and/or service arrangement smart contracts based on the arranged service. One or more steps of method 400 can be performed according to the service arrangement and/or service arrangement smart contract.

In embodiments, the service can be arranged upon activation of the service mode (i.e. at step 402). In embodiments, the service can be arranged upon activation of the service mode, and activation of one or other vehicle mode. For example, the service can be arranged only if the service mode is activated, and if the vehicle is in an idle or parked state, if approved by one or more driver, owner, and/or operator of the vehicle, and/or if not occupied by one or more drivers or passengers. In embodiments, the service can be arranged for a specific location and/or time. In embodiments, one or more servicing vehicle 205 can be selected to perform the service, including as described herein, such as based on an availability, inventory, and/or be location of the servicing vehicle 205.

The method 400 can include step 406 for navigating to one or more service locations. The service location can include as described with reference to FIG. 2. Step 406 can include navigating to one or more service locations for arrival at a specific arranged time or time window. For example, either of servicing vehicle 205 and/or serviced vehicle 210 can perform the navigation. Step 406 can include providing instruction to the one or more vehicles perform the navigation, e.g. in the form of a waypoint at a navigation system of the vehicle(s).

Method 400 can include step 408 for authenticating one or more parties to the service, and/or components of the vehicle serving system 200. Authentication can be performed as described with reference to FIG. 2, including during or after scanning the VIN (or receipt of other vehicle 210 or vehicle 205 authentication). Authentication can include determining an identity (such as by International Mobile Equipment Identity (IMEI)) of one or more components of the remote vehicle servicing system 200 are as assigned in the service agreement. Authentication can include determining that one or more components of the remote vehicle servicing system 200 are collocated, for example by determining that the one or more components of the remote vehicle servicing system 200 are proximate to each other. The authentication can include, e.g., performing one or more pairing of the one or more components (e.g. by Bluetooth, NFC, WiFi, and/or scanning of QR code), and/or performing one or more handshake(s). Authentication can include determining that one or more components of the remote vehicle servicing system 200 are collocated, including by comparing one or more locations of vehicle servicing system 200 components. Authentication can include providing and/or authenticating one or more private and/or public keys, and/or performing one or more factor based authentication (i.e. across multiple devices and/or system 200 components, and/or by one or more parties to the service). Step 408 can include executing an authentication component of the service agreement smart contract and/or updating a distributed ledger in the Blockchain associated with the service agreement smart contract (and/or associated with a party, non-party, and/or system 200 component) with authentication data. Executing an authentication component of the service agreement smart contract and/or updating a distributed ledger in the Blockchain associated with the service agreement smart contract can include determining that an identity of one or more parties (or non-parties), and/or an identity of one or more components of the remote vehicle servicing system 200 which are collocated for performing of the service have the identities as identified in the service agreement.

Method 400 can include step 410 for aligning the lift (e.g. vehicle lift system 215 and/or vehicle lift system 300). Instruction for alignment (including but not limited to locations of lift points 305 for the service vehicle 205) can be provided by one or more components of the remote vehicle servicing system 200, such as network connected server 230. Executing step 410 can include as described with reference to FIG. 3 and/or FIG. 4. Alignment can include aligning one or more lift mechanism 307 contact points 310 with one or more lift points 305 of the serviced vehicle 210. Alignment can include lifting the serviced vehicle 305 with the lift. Alignment can include lifting the serviced vehicle 305 with the lift based on one or more readings of a sensor (e.g. of the vehicle). Alignment can include lifting and/or otherwise aligning the lift and/or the serviced vehicle 305 such that a clearance is maintained.

Method 400 can include step 412 for updating one or more vehicle access based on the vehicle access settings. Vehicle access settings can be updated at the serviced vehicle 210, for example based on the service arrangement, and/or based on receipt of one or more updates to vehicle access settings (e.g. based upon one or more interactions with the system 200, e.g. as indicated by receipt of one or more interactions with devices 220, 222, 224).

Method 400 can include step 414 for performing one or more aspects of the service. Step 414 can include partially or completely completing the service (or aspects thereof). Step 414 can include performing one or more aspects of the service, including as described with reference to FIGS. 2-3. For example, step 414 can include performing one or more services as described herein, including by the servicing vehicle 205 and/or vehicle servicing system 200 operator. Step 414 can include determining that the service has been performed, including by performing one or more checks or inspections, such as evaluating one or more diagnostic codes (e.g. by one or more devices, or another component of the system) or performing other diagnostic checks. Step 416 can include exiting service mode (e.g. that was activated at step 402). The service mode can be exited after checking and/or verifying that the service has been fully or partially completed.

FIG. 4B illustrates another diagram of method 450 for performing vehicle servicing of one or more vehicles according to aspects of the present disclosure. Generally, one or more server can provide instruction for execution of method 450 (or one or more steps thereof). Thus, compared to FIG. 4A, FIG. 4B shows method 450 tailored for execution at one or more servers, such as server(s) 230 (e.g. at computing component thereof).

Although one or more steps of method 400 and method 450 may be shown sequentially, it is understood that one or more steps of method 400 and/or method 450 can be performed out of order. Methods 400 and 450 are merely non-limiting examples of performing vehicle servicing according to the present disclosure. One or more steps of method 400 and method 450 may be added, omitted, and/or performed with multiple steps, and it is understood that the methods and/or steps are within the scope of the disclosure.

Method 450 can include step 452 for receiving and/or providing notice (i.e. instruction and/or confirmation) of activation of service mode (at a vehicle, such as serviced vehicle 210).

Method 450 can include step 454 for arranging one or more service for a vehicle (such as service vehicle 210). Arranging of one or more service(s) can be performed as described herein, e.g. with reference to FIG. 2 and/or with reference to step 404 shown in FIG. 4A. For example, arrangement of one or more services can be according to a service agreement, and can include creating one or more service agreement smart contract (e.g. in the Blockchain) as described herein.

One or more server 230 can play an active role in arranging the one or more service(s), such as facilitating an agreement on one or more service arrangements, or on one or more aspects of the service. It is understood that arrangement of one or more service for a specific serviced vehicle, can be arranged in conjunction with arrangement for one or more service for other serviced vehicles, and by servicing vehicles in a fleet of servicing vehicles. Arrangement of the service and/or assigning of servicing vehicles (and other components/resources for the service) can be at least partially based on an availability, inventory, and/or be location of the servicing vehicle 205 (but also a fleet of such vehicles).

Method 450 can include step 455 for providing one or more instructions for performing of the service. The instructions can relate to one or more service dimensions, and/or to the arranged service and/or service agreement. This can include one or more instructions, such as instructions with navigation, authentication, alignment, vehicle access, and/or other information for one or more of the components of the remote vehicle servicing system 200. Steps 456, 458, 460 include example or instructions related to the service.

Method 450 can include step 456 for providing navigation instructions. Providing navigation instructions can be performed as described with reference to FIGS. 1A-2 and/or step 410.

Method 450 can include step 458 for providing one or more alignment instructions. Alignment instructions can include as described with reference to aligning one or more components of the remote vehicle servicing system 200 as described with reference to FIG. 2-3, and/or as described with reference to step 410. Alignment instructions can include the location of one or more lift points of the serviced vehicle. Alignment instructions can be based on locations based on the scanned vehicle identification and/or vehicle authentication. Alignment instructions can include information regarding coarse and/or fine alignment, for example, of vehicle lift system 215 and/or vehicle lift system 300 with respect to a serviced vehicle 210.

Method 450 can include step 460 for providing and/or updating vehicle access settings. Step 460 can be performed with reference to FIG. 2, and/or step 412.

Method 450 can include step 462 for authenticating one or more parties, non-parties, components of the remote vehicle servicing system 200, and/or aspects of the service. Step 462 can be performed as described with reference to FIG. 2, and/or step 408. Step 462 can include updating one or more instructions based on the authentication (e.g. instructions provided in steps 455-460). Thus, this method 450 can allow for dynamic vehicle servicing that updates based on the authentication. For example, whereas instructions may have been tailored for a serviced vehicle 210 with a first vehicle identification, one or more instructions can be updated based upon an identification determined at authentication step 462. By way of another example, whereas instructions (e.g. at steps 455-460) may have been tailored for service according to a first service agreement (e.g. as determined at step 454), step 462 can include updating the service agreement upon authentication at step 462, and thus updating one or more instructions for performing of the service accordingly based upon an identification determined at authentication step 462.

Method 450 can include step 464 for receiving notice (e.g. confirmation), from one or more components of the system, or parties to the service thereof, of partial or complete performance of one or more aspects of the service. It is understood that notice can be received automatically and/or in real-time with performance of aspects of the service. For example, this step 464 can be performed iteratively upon execution of one or more of the steps (e.g. of method 400) for performing the service. For example, this step 464 can be completed upon execution of step 414, and notice can be based on a result of step 414. Execution of one or more step 414 and/or 464 can also include (e.g. automatically), executing one or more components of a service agreement smart contract, e.g. a service level component, and/or another component which updates one or more distributed ledger in the Blockchain associated with the service agreement smart contract (and/or associated with a party, non-party, and/or system 200 component) as described herein.

In embodiments, step 464 for receiving notice (e.g. confirmation) can include receiving notice of a result of performance of the service. Thus, step 464 can include assisting with or completing or more learning operations of the system 200. Learning operations can utilize the status and/or results of performance of aspects of the service to optimize one or more resources (such as inventory and/or servicing vehicle(s)) 205 in arrangement of future services. For example, if an aspect of a service was performed in a time longer than expected, an estimated time for completion of that service can be updated accordingly (e.g. for other service agreements that can include the servicing vehicle 205), and/or more resources (e.g. second vehicles and/or operator/technician) can be assigned for performing that service for completion of subsequent services. In another aspect, learning operations can feed into subsequent negotiations for arrangement of services. For example, a subsequent or follow-on arrangement of a service can consider if one or more aspects of the service could not be performed due to the fault of the serviced vehicle 205 (e.g. if the servicing vehicle 205 was not afforded sufficient access to the serviced vehicle 210, and/or one or more party was unresponsive (e.g. by serviced vehicle owner/operator device 222)).

Method 450 can include step 466 for providing notice (i.e. instruction and/or confirmation), to one or more components of the remote vehicle servicing system 200, that service has been completed, and/or that Service Mode can be exited. For example, the notice can be provided to the serviced vehicle 210 and/or to one or more devices 220,222, 224. Upon receipt of the notice, the serviced vehicle 210 can exit service mode. As another example, notice of completion of one or more aspects of the service can be used to alert one or more parties of completion of the service (e.g. by providing a notification to one or more of the devices 220,222, 224).

At each of steps 402-466 shown in FIG. 4A and FIG. 4B, one or more information or data can be provided to the network 225 or other network connected components, such as authentication data, and/or a status of performance of one or more aspects of the service agreement. At each of steps 402-466, one or more status of a component of the system 200 can be updated such that the system 200 can allow for real-time notification of at least one of a location of a component, and or current, past, and/or future action of a component. Real-time notification can include access to time-series data that can include a sequence of values associated with one or more signals generated by the system and monitored over a period of time. At each of steps 402-466, one or more distributed ledgers in the Blockchain can be updated with one or more information, such as data as described herein.

As used herein, the terms circuit, system, and component might describe a given unit of functionality that can be performed in accordance with one or more embodiments of the present application. As used herein, a component might be implemented utilizing any form of hardware, software, or a combination thereof. For example, one or more processors, controllers, ASICs, PLAs, PALs, CPLDs, FPGAs, logical components, software routines or other mechanisms might be implemented to make up a component. Various components described herein may be implemented as discrete components or described functions and features can be shared in part or in total among one or more components. In other words, as would be apparent to one of ordinary skill in the art after reading this description, the various features and functionality described herein may be implemented in any given application. They can be implemented in one or more separate or shared components in various combinations and permutations. Although various features or functional elements may be individually described or claimed as separate components, it should be understood that these features/functionality can be shared among one or more common software and hardware elements. Such a description shall not require or imply that separate hardware or software components are used to implement such features or functionality.

Where components are implemented in whole or in part using software, these software elements can be implemented to operate with a computing or processing component capable of carrying out the functionality described with respect thereto. One such example computing component is shown in FIG. 5. Various embodiments are described in terms of this example-computing component 500. After reading this description, it will become apparent to a person skilled in the relevant art how to implement the application using other computing components or architectures.

Referring now to FIG. 5, computing component 500 may represent, for example, computing or processing capabilities found within a self-adjusting display, desktop, laptop, notebook, and tablet computers. They may be found in hand-held computing devices (tablets, PDA's, smart phones, cell phones, palmtops, etc.). They may be found in workstations or other devices with displays, servers, or any other type of special-purpose or general-purpose computing devices as may be desirable or appropriate for a given application or environment. Computing component 500 might also represent computing capabilities embedded within or otherwise available to a given device. For example, a computing component might be found in other electronic devices such as, for example, portable computing devices, and other electronic devices that might include some form of processing capability. For example, computing component might be found in components making up devices 220, 222, 224, service mode system 100, vehicle lift system 215, serviced vehicle 210, and/or servicing vehicle 205.

Computing component 500 might include, for example, one or more processors, controllers, control components, or other processing devices. This can include a processor, and/or any one or more of the components making up devices 220, 222, 224, vehicle 100, vehicle lift system 215, servicing vehicle 205, and/or serviced vehicle 210. Processor 504 might be implemented using a general-purpose or special-purpose processing engine such as, for example, a microprocessor, controller, or other control logic. Processor 504 may be connected to a bus 502. However, any communication medium can be used to facilitate interaction with other components of computing component 500 or to communicate externally. In embodiments, processor 504 may fetch, decode, and/or execute one or more instructions to control processes and/or operations for enabling vehicle servicing as described herein. For example, instructions can correspond to steps for performing one or more steps of method 400 shown in FIG. 4A.

Computing component 500 might also include one or more memory components, simply referred to herein as main memory 508. For example, random access memory (RAM) or other dynamic memory, might be used for storing information and instructions to be fetched, decoded, and/or executed by processor 504. Main memory 508 might also be used for storing temporary variables or other intermediate information during execution of instructions to be fetched, decoded, and/or executed by processor 504. Computing component 500 might likewise include a read only memory (“ROM”) or other static storage device coupled to bus 502 for storing static information and instructions for processor 504.

The computing component 500 might also include one or more various forms of information storage mechanism 510, which might include, for example, a media drive 512 and a storage unit interface 520. The media drive 512 might include a drive or other mechanism to support fixed or removable storage media 514. For example, a hard disk drive, a solid-state drive, a magnetic tape drive, an optical drive, a compact disc (CD) or digital video disc (DVD) drive (R or RW), or other removable or fixed media drive might be provided. Storage media 514 might include, for example, a hard disk, an integrated circuit assembly, magnetic tape, cartridge, optical disk, a CD or DVD. Storage media 514 may be any other fixed or removable medium that is read by, written to or accessed by media drive 512. As these examples illustrate, the storage media 514 can include a computer usable storage medium having stored therein computer software or data.

In alternative embodiments, information storage mechanism 510 might include other similar instrumentalities for allowing computer programs or other instructions or data to be loaded into computing component 500. Such instrumentalities might include, for example, a fixed or removable storage unit 522 and an interface 520. Examples of such storage units 522 and interfaces 520 can include a program cartridge and cartridge interface, a removable memory (for example, a flash memory or other removable memory component) and memory slot. Other examples may include a PCMCIA slot and card, and other fixed or removable storage units 522 and interfaces 520 that allow software and data to be transferred from storage unit 522 to computing component 500.

Computing component 500 might also include a communications interface 524. Communications interface 524 might be used to allow software and data to be transferred between computing component 500 and external devices. Examples of communications interface 524 might include a modem or softmodem, a network interface (such as Ethernet, network interface card, IEEE 802.XX or other interface). Other examples include a communications port (such as for example, a USB port, IR port, RS232 port Bluetooth® interface, or other port), or other communications interface. Software/data transferred via communications interface 524 may be carried on signals, which can be electronic, electromagnetic (which includes optical) or other signals capable of being exchanged by a given communications interface 524. These signals might be provided to communications interface 524 via a channel 528. Channel 528 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media. Such media may be, e.g., memory 508, storage unit 520, media 514, and channel 528. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing component 500 to perform features or functions of the present application as discussed herein.

It should be understood that the various features, aspects and functionality described in one or more of the individual embodiments are not limited in their applicability to the particular embodiment with which they are described. Instead, they can be applied, alone or in various combinations, to one or more other embodiments, whether or not such embodiments are described and whether or not such features are presented as being a part of a described embodiment. Thus, the breadth and scope of the present application should not be limited by any of the above-described exemplary embodiments.

Terms and phrases used in this document, and variations thereof, unless otherwise expressly stated, should be construed as open ended as opposed to limiting. As examples of the foregoing, the term “including” should be read as meaning “including, without limitation” or the like. The term “example” is used to provide exemplary instances of the item in discussion, not an exhaustive or limiting list thereof. The terms “a” or “an” should be read as meaning “at least one,” “one or more” or the like; and adjectives such as “conventional,” “traditional,” “normal,” “standard,” “known.” Terms of similar meaning should not be construed as limiting the item described to a given time period or to an item available as of a given time. Instead, they should be read to encompass conventional, traditional, normal, or standard technologies that may be available or known now or at any time in the future. Where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “component” does not imply that the aspects or functionality described or claimed as part of the component are all configured in a common package. Indeed, any or all of the various aspects of a component, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A method executed at a server, comprising:
arranging for a performance of a service on a first vehicle according to a service agreement;
providing one or more instructions relating to the service to a second vehicle, the instructions specifying at least one aspect of the service to be performed at the location of the first vehicle by the second vehicle or an operator of the second vehicle; and
receiving a confirmation of performance of at least one aspect of the service at the location of the first vehicle.

2. The method of claim 1, further comprising providing one or more instructions relating to alignment of an automatic lift system coupled to the second vehicle, the automatic lift system configured for lifting the first vehicle for performance of the service.

3. The method of claim 2, further comprising providing one or more instructions for lifting of the first vehicle for performance of the service, wherein the instructions comprise lifting the first vehicle according to a clearance signal from one or more sensor physically coupled to the first vehicle or the automatic lift system.

4. The method of claim 2, wherein the one or more instructions relating to alignment of an automatic lift system coupled to the second vehicle and configured for lifting the first vehicle for performance of the service, include: (i) the locations of one or more lift points for the first vehicle, and (ii) one or more translation or articulation instructions for the automatic lift system; wherein the one or more translation or articulation instructions are configured to allow one or more contact points of the automatic lift system to contact the one or more lift points of the first vehicle.

5. The method of claim 1, wherein the service agreement comprises an agreement for vehicle access, and wherein the instructions relating to the service further comprise vehicle access instructions.

6. The method of claim 5, further comprising providing instructions relating to the service to the first vehicle, wherein the instructions specify configuring one or more vehicle controls for controlling one or more vehicle access according to a vehicle access setting based on the agreement for vehicle access.

7. The method of claim 6, wherein the vehicle access setting comprise one or more settings for access to at least one compartment of the first vehicle, and one or more settings for access to at least one data related to the first vehicle.

8. The method of claim 7, further comprising:
authenticating a device related to the service agreement;
receiving a request to access to a compartment of the first vehicle;
providing a notification to the device of the request to access the compartment; and
receiving a notification regarding the request to access the compartment from the device; and
providing an instruction to the first vehicle for configuring one or more vehicle controls for controlling access to the compartment of the first vehicle according to the received notification regarding the request to access the compartment.

9. The method of claim 1, further comprising:
providing instructions relating to the service to the first vehicle, wherein the instructions specify configuring one or more vehicle controls for controlling one or more vehicle access according to vehicle access settings based on an agreement for vehicle access within the service agreement; wherein the vehicle access settings comprise one or more settings for access to at least one compartment of the first vehicle; and wherein the agreement for vehicle access comprises an agreement for vehicle access by a third party, and wherein one or more settings for access to the at least one compartment of the first vehicle specify a level of access to the at least one compartment of the first vehicle by the third party.

10. The method of claim 1, wherein arranging for a performance of a service to the first vehicle according to the service agreement comprises creating a service agreement smart contract; and wherein receiving a confirmation of performance of at least one aspect of the service comprises receiving a confirmation of execution of one or more components of the service agreement smart contract to automatically update one or more distributed ledger in a Blockchain.

11. The method of claim 1, further comprising authenticating the presence of the second vehicle at a location of the first vehicle by determining that a respective identity of the first vehicle and the second vehicle are as identified in the service agreement.

12. The method of claim 1, wherein providing instructions relating to the service to the second vehicle specify the second vehicle to recharge the first vehicle.

13. The method of claim 1, further comprising providing one or more instructions to a robotic vehicle servicing system operator for performance of at least one aspect of the service by the robotic vehicle servicing system operator.

14. The method of claim 1, further comprising transmitting an instruction for the first vehicle to exit a service mode upon receipt of the confirmation of performance of at least one aspect of the service; wherein receiving the confirmation of performance of at least one aspect of the service comprises receiving a confirmation that the service was completed, and wherein the at least one aspect of the service comprises performance of a maintenance or parts upgrade on the first vehicle.

15. A networked connected servicing vehicle, comprising:
a vehicle body;
an actuation component configured for actuating the servicing vehicle;
a communications component through which the network connected servicing vehicle:
negotiates one or more service agreement for servicing a serviced vehicle;
receives a location of the serviced vehicle to which the servicing vehicle travels to perform the servicing of the serviced vehicle;
authenticates the presence of the servicing vehicle when proximate to the serviced vehicle; and
receives one or more instructions for the servicing of the serviced vehicle at the location of the serviced vehicle.

16. The networked connected servicing vehicle of claim 15, further comprising:
an automatic lift system coupled to the vehicle body, wherein the automatic lift system is configured to:
align the automatic lift system with the serviced vehicle; and
lift the serviced vehicle for performance of the service based on a clearance signal from one or more sensor physically coupled to the serviced vehicle or the automatic lift system.

17. The networked connected servicing vehicle of claim 16, wherein the vehicle body comprises one or more battery configured to recharge the serviced vehicle if the service agreement comprises a recharge service; wherein the battery is physically coupled to the vehicle body such that the battery comprises at least a portion of a ballast weight of the vehicle body, the ballast weight configured for allowing the lift system to lift the serviced vehicle.

18. The networked connected servicing vehicle of claim 15, further comprising:
a sensor;
wherein the presence of the servicing vehicle proximate to the serviced vehicle is authenticated by scanning a serviced vehicle identification by the sensor of the mobile servicing vehicle.

19. The networked connected servicing vehicle of claim 18, further comprising:
an automatic lift system coupled to the vehicle body; the automatic lift system configured to determine the locations of one or more lift points for the serviced vehicle based on the scanned vehicle identification; and
wherein the automatic lift system is configured to lift the serviced vehicle for performance of the service by contacting one or more contact points of the automatic lift system with one or more lift points of the serviced vehicle.

20. The networked connected servicing vehicle of claim 15, wherein the one or more instructions for the servicing of the serviced vehicle at the location of the serviced vehicle specify one or more vehicle access setting, wherein the vehicle access settings specify a level of access to at least one compartment of the first vehicle and to one or more data of the serviced vehicle, and wherein access to the serviced vehicle is based on the authentication.
